(19) United States
(12) Patent Application Publication
(10) Pub. No.: US 2022/0075029 A1
(43) Pub. Date: Mar. 10, 2022

(54) MEASURING DEVICE, DISTANCE MEASURING DEVICE AND MEASURING METHOD

(71) Applicant: SONY SEMICONDUCTOR SOLUTIONS CORPORATION, KANAGAWA (JP)

(72) Inventor: KUMIKO MAHARA, KANAGAWA (JP)

(21) Appl. No.: 17/310,080

(22) PCT Filed: Jan. 17, 2020
(86) PCT No.: PCT/JP2020/001589

§ 371 Date: Jul. 15, 2021

(30) Foreign Application Priority Data
Jan. 24, 2019 (JP) 2019-010672

(51) Int. Cl. G01S 7/487; G01S 17/10

(52) U.S. Cl. CPC G01S 7/487; G01S 17/10

(57) ABSTRACT

A light receiving unit (100) according to an embodiment includes: a plurality of light receiving elements that is disposed in a matrix array and that is included in the target region. A controller (103) designates an addition region including two or more light receiving elements of the plurality of light receiving elements, and controls scanning with the designated addition region as a unit. A time measurement unit (110) measures according to the scanning the time from the light emission timing when the light source (2) emits light to the light reception timing when each of the light receiving elements included in the addition region receives the light to acquire the measured value. A generation unit (111) adds the number of measured values in each predetermined time range based on the measured values to generate a histogram related to the addition region. The controller designates a first addition region and a second addition region whose part overlaps the first addition region as an addition region.

### FIELD

The present invention relates to a measuring device, a distance measuring device and a measuring method.

### BACKGROUND

As one of the distance measuring methods for measuring the distance to an object to be measured using light, a distance measuring method called a direct time of flight (ToF) method is known. In the distance measuring process by the direct ToF method, the light receiving element receives the reflected light when the light emitted from the light source is reflected by the object to be measured, and the time from the emission of the light to the reception as the reflected light is measured. A histogram is created based on the measured time, and the distance to the target is calculated based on this histogram. Further, in the direct ToF method, there is known a configuration in which distance measurement is performed using a pixel array in which light receiving elements are disposed in a two-dimensional lattice pattern.

In the distance measurement using a pixel array, when all the light receiving elements included in the pixel array are driven at the same time or the distance measurement result is output, there are restrictions in terms of power consumption, data communication band, circuit scale, and the like. Therefore, a division driving method has been proposed in which the light receiving region of the pixel array is divided into a plurality of regions, and each divided region is sequentially driven to output the distance measurement result.

### CITATION LIST

### Patent Literature

Patent Literature 1: JP 2017-173298 A

### SUMMARY

### Technical Problem

In the above-mentioned division drive, each divided region obtained by dividing the light receiving region of the pixel array represents a unit of resolution. That is, the smaller the area of the divided region, the higher the resolution of distance measurement. On the other hand, by increasing the area of the divided region and increasing the number of light receiving elements included in the divided region, the addition number in the histogram increases and the distance measurement accuracy is high. In this way, in the existing distance measuring method using the direct ToF method, there is a trade-off relationship between the distance measurement resolution and the distance measurement accuracy, and it is difficult to perform distance measurement with high resolution and high accuracy.

An object of the present disclosure is to provide a measuring device, a distance measuring device, and a measuring method capable of measuring a distance with high resolution and high accuracy.

### Solution to Problem

For solving the problem described above, a measuring device according to one aspect of the present disclosure has a light receiving unit having a plurality of light receiving elements that is disposed in a matrix array and that is included in a target region; a controller that designates an addition region including two or more light receiving elements of the plurality of light receiving elements and that controls scanning with the designated addition region as a unit; and a time measurement unit that measures, according to the scanning, a time from light emission timing when a light source emits light to light reception timing when each light receiving element included in the addition region receives the light to acquire a measured value, wherein the controller designates, as the addition region, a first addition region and a second addition region whose part overlaps the first addition region.

### BRIEF DESCRIPTION OF DRAWINGS

FIG. 1 is a diagram schematically illustrating distance measurement by the direct ToF method applicable to the embodiment.

FIG. 2 is a diagram illustrating an example histogram based on the time of light reception applicable to the embodiment.

FIG. 3 is a block diagram illustrating a configuration of an example of an electronic device including a distance measuring device according to the embodiment.

FIG. 4 is a block diagram illustrating in more detail the configuration of an example of a distance measuring device applicable to the embodiment.

FIG. 5 is a diagram illustrating a basic configuration example of a pixel circuit applicable to the embodiment.

FIG. 6 is a schematic diagram illustrating an example of the configuration of a device applicable to the distance measuring device according to the embodiment.

FIG. 7 is a diagram illustrating a more specific configuration example of a pixel array unit according to the embodiment.

FIG. 8A is a diagram illustrating an example of a detailed configuration of the pixel array unit according to the embodiment.

FIG. 8B is a diagram illustrating an example of a detailed configuration of the pixel array unit according to the embodiment.

FIG. 9 is a diagram illustrating an example of a configuration for reading a signal Vpls from each pixel circuit according to the embodiment.

FIG. 10A is a diagram for explaining a distance measuring method by an existing technique.

FIG. 10B is a diagram for explaining a distance measuring method by an existing technique.

FIG. 11A is a diagram schematically illustrating a distance measuring method according to the first embodiment.

FIG. 11B is a diagram schematically illustrating a distance measuring method according to the first embodiment.

FIG. 11C is a diagram schematically illustrating a distance measuring method according to the first embodiment.

FIG. 11D is a diagram schematically illustrating a distance measuring method according to the first embodiment.

FIG. 12 is a diagram illustrating an example of an offset according to the first embodiment.

FIG. 13 is a sequence diagram of an example illustrating a method of designating an offset according to the first embodiment.

FIG. 14 is a flowchart illustrating an example of a distance measuring process according to the first embodiment.

FIG. 15 is a diagram schematically illustrating an example in which the height and the movement width of the scan region are variable according to the modification of the first embodiment.

FIG. 16 is a diagram schematically illustrating a state of a pixel array unit according to the second modification of the first embodiment.

FIG. 17 is a diagram illustrating a usage example in which the distance measuring device according to the first embodiment is used according to the second embodiment.

FIG. 18 is a block diagram illustrating a schematic configuration example of a vehicle control system, which is an example of a moving object control system to which the technique according to the present disclosure can be applied.

FIG. 19 is a diagram illustrating an example of an installation position of an imaging unit.

### DESCRIPTION OF EMBODIMENTS

Hereinafter, the embodiments of the present disclosure will be described in detail with reference to the drawings. In the following embodiments, the same parts are designated by the same reference numerals, so that duplicate description will be omitted.

### Technology Applicable to Each Embodiment

The present disclosure relates to a technique for performing distance measurement using light. Prior to the description of each embodiment of the present disclosure, the techniques applicable to each embodiment will be described for ease of understanding. In each embodiment, the direct time of flight (ToF) method is applied as the distance measuring method. The direct ToF method is a method in which the light receiving element receives the reflected light when the light emitted from the light source is reflected by the object to be measured, and the distance is measured based on the time difference between the light emission timing and the light reception timing.

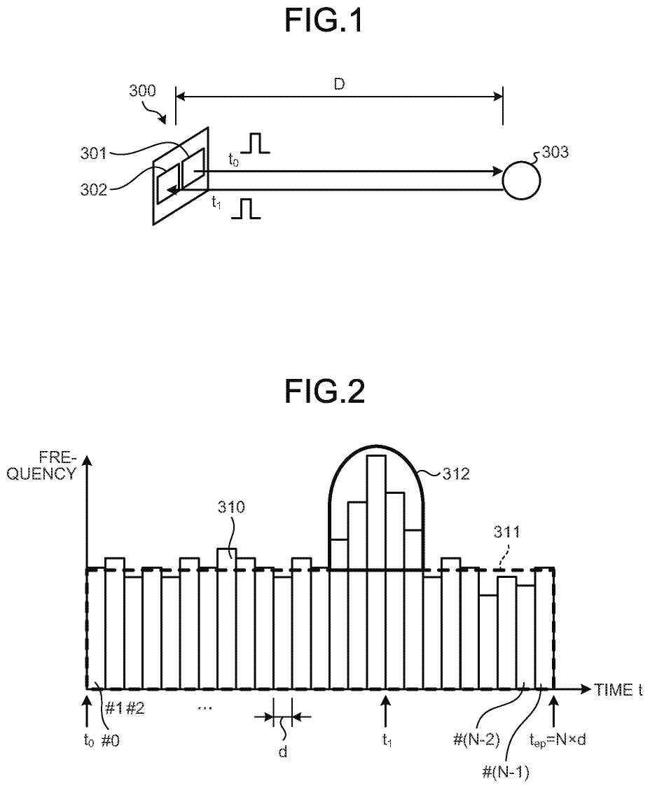

The direct ToF method of distance measurement will be schematically described with reference to FIGS. 1 and 2. FIG. 1 is a diagram schematically illustrating distance measurement by the direct ToF method applicable to each embodiment. A distance measuring device 300 includes a light source unit 301 and a light receiving unit 302. The light source unit 301 is, for example, a laser diode, and is driven so as to emit the laser beam in a pulsed manner. The light emitted from the light source unit 301 is reflected by an object to be measured 303 and is received by the light receiving unit 302 as reflected light. The light receiving unit 302 includes a light receiving element that converts light into an electrical signal by photoelectric conversion to output a signal corresponding to the received light.

Here, the time when the light source unit 301 emits light (light emission timing) is time t₀, and the time when the light receiving unit 302 receives the reflected light when the light emitted from the light source unit 301 is reflected by the object to be measured 303 (light reception timing) is t₁. Assuming that the constant c is the speed of light (2.9979×10⁸ [m/sec]), the distance D between the distance measuring device 300 and the object to be measured 303 is calculated by the following equation (1).

D=(c/2)×(t₁−t₀) (1)

The distance measuring device 300 repeats the above-mentioned process a plurality of times. The light receiving unit 302 may include a plurality of light receiving elements, and the distance D may be calculated based on each light reception timing when the reflected light is received by each light receiving element. The distance measuring device 300 classifies time tₘ (called the light receiving time tₘ) from time t₀ at the light emission timing to the light reception timing when the light is received by the light receiving unit 302 based on the class (bins) to generate a histogram.

The light received by the light receiving unit 302 during the light receiving time tₘ is not limited to the reflected light when the light emitted from the light source unit 301 is reflected by the object to be measured. For example, the ambient light around the distance measuring device 300 (light receiving unit 302) is also received by the light receiving unit 302.

FIG. 2 is a diagram illustrating an example histogram based on the time when the light receiving unit 302 receives light applicable to each embodiment. In FIG. 2, the horizontal axis indicates the bin and the vertical axis indicates the frequency for each bin. The bin is a classification of the light receiving time tₘ for each predetermined unit time d. Specifically, bin #0 represents 0≤tₘ<d, bin #1 represents d≤tₘ<2×d, bin #2 represents 2×d≤tₘ<3×d, . . . , and bin #(N−2) represents (N−2)×d≤tₘ<(N−1)×d. When the exposure time of the light receiving unit 302 is time tₑₚ, tₑₚ=N×d.

The distance measuring device 300 counts the number of times the light receiving time tₘ is acquired based on the bin to obtain the frequency 310 for each bin to generate a histogram. Here, the light receiving unit 302 also receives light other than the reflected light reflected when the light emitted from the light source unit 301 is reflected. As an example of such light other than the target reflected light, there is the above-mentioned ambient light. The portion indicated by the range 311 in the histogram includes the ambient light component due to the ambient light. The ambient light is light that is randomly incident on the light receiving unit 302 and is noise with respect to the reflected light of interest.

On the other hand, the target reflected light is light received according to a specific distance and appears as an active light component 312 in the histogram. The bin corresponding to the frequency of the peak in the active light component 312 is the bin corresponding to the distance D of the object to be measured 303. By acquiring the representative time of the bin (for example, the time in the center of the bin) as the time t₁ described above, the distance measuring device 300 can calculate the distance D to the object to be measured 303 according to the above equation (1). In this way, by using a plurality of light receiving results, it is possible to perform appropriate distance measurement for random noise.

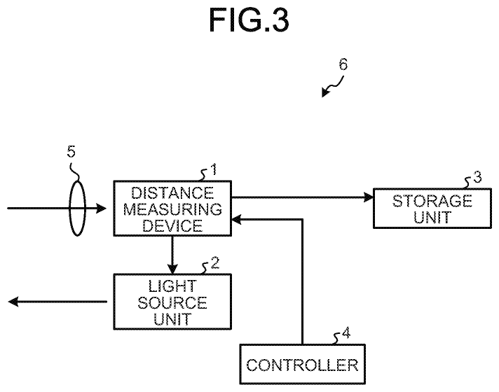

FIG. 3 is a block diagram illustrating a configuration of an example of an electronic device including the distance measuring device according to each embodiment. In FIG. 3, an electronic device 6 includes a distance measuring device 1, a light source unit 2, a storage unit 3, a controller 4, and an optical system 5.

The light source unit 2 corresponds to the light source unit 301 described above and is a laser diode, and is driven so as to emit the laser beam in a pulsed manner, for example. A vertical cavity surface emitting laser (VCSEL) that emits the laser beam can be applied for the light source unit 2 as a face light source. Not limited to this, the light source unit 2 may have a configuration in which an array in which laser diodes are disposed on a line may be used, and the laser beam emitted from the laser diode array is scanned in a direction perpendicular to the line. Furthermore, it may have a configuration in which a laser diode as a single light source is used and the laser beam emitted from the laser diode is scanned in the horizontal and vertical directions.

The distance measuring device 1 includes a plurality of light receiving elements corresponding to the light receiving unit 302 described above. The plurality of light receiving elements are, for example, disposed in a two-dimensional lattice to form a light receiving face. The optical system 5 guides light incident from the outside to the light receiving face included in the distance measuring device 1.

The controller 4 controls the overall operation of the electronic device 6. For example, the controller 4 supplies the distance measuring device 1 with a light emitting trigger that is a trigger for causing the light source unit 2 to emit light. The distance measuring device 1 causes the light source unit 2 to emit light at timing based on this light emitting trigger to store time to indicating the light emission timing. Further, the controller 4 sets a pattern for distance measurement for the distance measuring device 1 in response to an instruction from the outside, for example.

The distance measuring device 1 counts the number of times that time information (light receiving time tₘ) indicating the timing at which light is received by the light receiving face is acquired within a predetermined time range to obtain the frequency for each bin to generate the above-mentioned histogram. The distance measuring device 1 further calculates the distance D to the object to be measured based on the generated histogram. The information indicating the calculated distance D is stored in the storage unit 3.

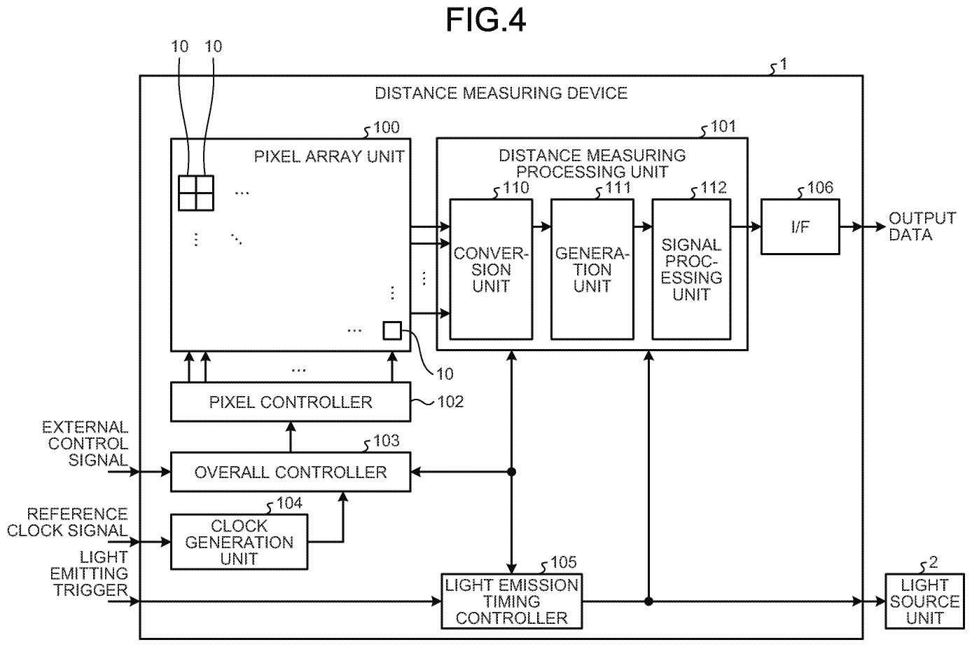

FIG. 4 is a block diagram illustrating in more detail the configuration of an example of the distance measuring device 1 applicable to each embodiment. In FIG. 4, the distance measuring device 1 includes a pixel array unit 100, a distance measuring processing unit 101, a pixel controller 102, an overall controller 103, a clock generation unit 104, a light emission timing controller 105, and an interface (I/F) 106. The pixel array unit 100, the distance measuring processing unit 101, the pixel controller 102, the overall controller 103, the clock generation unit 104, the light emission timing controller 105, and the interface (I/F) 106 are disposed on, for example, one semiconductor chip.

In FIG. 4, the overall controller 103 controls the overall operation of the distance measuring device 1 according to, for example, a program incorporated in advance. Further, the overall controller 103 can also perform control according to an external control signal supplied from the outside. The clock generation unit 104 generates one or more clock signals used in the distance measuring device 1 based on the reference clock signal supplied from the outside. The light emission timing controller 105 generates a light emission control signal indicating the light emission timing according to the light emitting trigger signal supplied from the outside. The light emission control signal is supplied to the light source unit 2 and to the distance measuring processing unit 101.

The pixel array unit 100 includes a plurality of pixel circuits 10 each including a light receiving element, which are disposed in a two-dimensional lattice pattern. The operation of each pixel circuit 10 is controlled by the pixel controller 102 according to the instruction of the overall controller 103. For example, the pixel controller 102 may control the reading of the pixel signal from each pixel circuit 10 for each block including (pxq) pixel circuits 10 with p pixels in the row direction and q pixels in the column direction. Further, the pixel controller 102 can scan respective pixel circuits 10 in the row direction and further scan them in the column direction with the block as a unit to read a pixel signal from respective pixel circuits 10. Not limited to this, the pixel controller 102 can also control each pixel circuit 10 independently. Further, the pixel controller 102 can set a predetermined region of the pixel array unit 100 as a target region, and can set the pixel circuits 10 included in the target region as the target pixel circuits 10 from which a pixel signal is to be read. Furthermore, the pixel controller 102 can collectively scan a plurality of rows (plurality of lines), further perform scanning in the plurality of rows (plural lines) in the column direction, and read a pixel signal from each pixel circuit 10.

The pixel signal read from each pixel circuit 10 is supplied to the distance measuring processing unit 101. The distance measuring processing unit 101 includes a conversion unit 110, a generation unit 111, and a signal processing unit 112.

The pixel signal read from each pixel circuit 10 to output from the pixel array unit 100 is supplied to the conversion unit 110. Here, the pixel signal is asynchronously read from each pixel circuit 10 and supplied to the conversion unit 110. That is, the pixel signal is read from the light receiving element and is output according to the timing at which light is received by each pixel circuit 10.

The conversion unit 110 converts the pixel signal supplied from the pixel array unit 100 into digital information. That is, the pixel signal supplied from the pixel array unit 100 is output corresponding to the timing when light is received by the light receiving element included in the pixel circuit 10 corresponding to the pixel signal. The conversion unit 110 converts the supplied pixel signal into time information indicating the timing.

The generation unit 111 generates a histogram based on the time information in which the pixel signal is converted by the conversion unit 110. Here, the generation unit 111 counts the time information based on the unit time d set by a setting unit 113 to generate the histogram. The details of the histogram generation process by the generation unit 111 will be described later.

The signal processing unit 112 performs the predetermined arithmetic process based on the data of the histogram generated by the generation unit 111, and calculates, for example, distance information. The signal processing unit 112 creates a curve approximation of the histogram based on, for example, the data of the histogram generated by the generation unit 111. The signal processing unit 112 can detect the peak of the curve to which this histogram approximates and obtain the distance D based on the detected peak.

When the signal processing unit 112 performs a curve approximation of the histogram, the signal processing unit 112 can perform a filter process to the curve to which the histogram approximates. For example, the signal processing unit 112 can suppress a noise component by performing a low pass filter process on a curve to which the histogram approximates.

The distance information obtained by the signal processing unit 112 is supplied to an interface 106. The interface 106 outputs the distance information supplied from the signal processing unit 112 to the outside as output data. For example, a mobile industry processor interface (MIPI) can be used as the interface 106.

In the above description, the distance information obtained by the signal processing unit 112 is output to the outside via the interface 106, but the embodiment is not limited to this example. That is, the histogram data, which is data of the histogram generated by the generation unit 111, may be output from the interface 106 to the outside. In this case, the information indicating the filter coefficient can be omitted from the distance measurement condition information set by the setting unit 113. The histogram data output from the interface 106 is supplied to, for example, an external information processing device, and is appropriately processed.

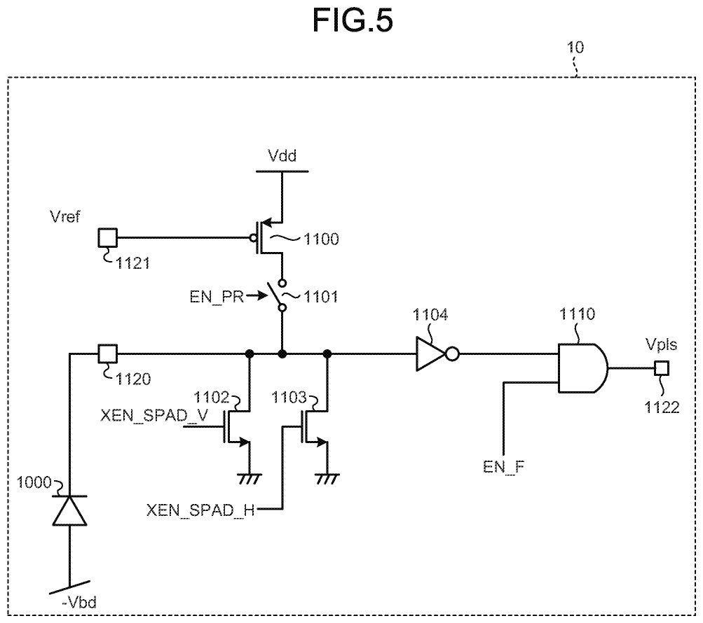

FIG. 5 is a diagram illustrating a basic configuration example of the pixel circuit 10 applicable to each embodiment. In FIG. 5, the pixel circuit 10 includes a light receiving element 1000, transistors 1100, 1102, and 1103, an inverter 1104, a switch unit 1101, and an AND circuit 1110.

The light receiving element 1000 converts the incident light into an electrical signal by photoelectric conversion to output the signal. In each embodiment, the light receiving element 1000 converts the incident photon (photon) into an electrical signal by photoelectric conversion to output a pulse corresponding to the entry of the photon. In each embodiment, a single photon avalanche diode is used as the light receiving element 1000. Hereinafter, the single photon avalanche diode is referred to as a single photon avalanche diode (SPAD). The SPAD has the characteristic in which when a large negative voltage that causes avalanche multiplication is applied to the cathode, the electrons generated in response to the entry of one photon cause avalanche multiplication and a large current flows. By utilizing this characteristic of the SPAD, it is possible to detect the entry of one photon with high sensitivity.

In FIG. 5, the light receiving element 1000, which is a SPAD, has a cathode connected to a coupling unit 1120 and an anode connected to a voltage source of the voltage (−Vbd). The voltage (−Vbd) is a large negative voltage that generates an avalanche multiplication for the SPAD. The coupling unit 1120 is connected to one end of the switch unit 1101 whose on (closed) and off (open) are controlled according to a signal EN_PR. The other end of the switch unit 1101 is connected to the drain of a transistor 1100, which is a P-channel metal oxide semiconductor field effect transistor (MOSFET). The source of the transistor 1100 is connected to a power supply voltage Vdd. Further, a coupling unit 1121 to which a reference voltage Vref is supplied is connected to the gate of the transistor 1100.

The transistor 1100 is a current source that outputs a current corresponding to the power supply voltage Vdd and the reference voltage Vref from the drain. With such a configuration, a reverse bias is applied to the light receiving element 1000. When a photon is incident on the light receiving element 1000 with the switch unit 1101 turned on, the avalanche multiplication is started and a current flows from the cathode toward the anode of the light receiving element 1000.

The signal extracted from the connection point between the drain of the transistor 1100 (one end of the switch unit 1101) and the cathode of the light receiving element 1000 is input to the inverter 1104. The inverter 1104 performs, for example, a threshold value determination on the input signal, inverts the signal each time the signal exceeds the threshold value in the positive direction or the negative direction to output the signal as the signal Vpls, which is a pulsed output signal.

The signal Vpls output from the inverter 1104 is input to the first input port of the AND circuit 1110. A signal EN_F is input to the second input port of the AND circuit 1110. The AND circuit 1110 outputs the signal Vpls from the pixel circuit 10 via a terminal 1122 when both the signal Vpls and the signal EN_F are in the high state.

In FIG. 5, the coupling unit 1120 is further connected to the drains of transistors 1102 and 1103, each of which is an N-channel MOSFET. The sources of the transistors 1102 and 1103 are connected, for example, to the ground potential. A signal XEN_SPAD_V is input to the gate of the transistor 1102. A signal XEN_SPAD_H is input to the gate of the transistor 1103. When at least one of these transistors 1102 and 1103 is in the off state, the cathode of the light receiving element 1000 is forcibly set to the ground potential, and the signal Vpls is set in the low state.

The signals XEN_SPAD_V and XEN_SPAD_H are used as vertical and horizontal control signals, respectively, in a two-dimensional lattice pattern in which respective pixel circuits 10 are disposed in the pixel array unit 100. As a result, the on/off state of each pixel circuit 10 included in the pixel array unit 100 can be controlled for each pixel circuit 10. The on state of the pixel circuit 10 is a state in which the signal Vpls can be output, and the off state of the pixel circuit 10 is a state in which the signal Vpls cannot be output.

For example, in the pixel array unit 100, the signal XEN_SPAD_H is set to the state in which the transistor 1103 is turned on for consecutive q columns of the two-dimensional lattice, and the signal XEN_SPAD_V is set to the state in which the transistor 1102 is turned on for consecutive p rows. As a result, the output of each light receiving element 1000 can be enabled in a block of p rows×q columns. In addition, since the signal Vpls is output by the AND circuit 1110 from the pixel circuit 10 by the logical product with the signal EN_F, for example, it is possible to control whether the output of each light receiving element 1000 enabled by the signals XEN_SPAD_V and XEN_SPAD_H is enabled/disabled in more detail.

Further, by supplying the signal EN_PR that turns off the switch unit 1101, for example, to the pixel circuit 10 including the light receiving element 1000 whose output is to be disabled, it is possible to stop the supply of the power supply voltage Vdd to the light receiving element 1000, and the pixel circuit 10 can be turned off. This makes it possible to reduce the power consumption of the pixel array unit 100.

These signals XEN_SPAD_V, XEN_SPAD_H, EN_PR, and EN_F are generated by the overall controller 103 based on the parameters stored in the register of the overall controller 103, for example. The parameters may be stored in the register in advance, or may be stored in the register according to an external input. Each of the signals XEN_SPAD_V, XEN_SPAD_H, EN_PR, and EN_F generated by the overall controller 103 is supplied to the pixel array unit 100 by the pixel controller 102.

The control by the signals EN_PR, XEN_SPAD_V, and XEN_SPAD_H using the switch unit 1101 and the transistors 1102 and 1103 described above is performed by using the analog voltage. On the other hand, the control by the signal EN_F using the AND circuit 1110 is performed by using the logic voltage. Therefore, the control by the signal EN_F can be performed at a lower voltage than the control by the signals EN_PR, XEN_SPAD_V, and XEN_SPAD_H, and is easy to handle.

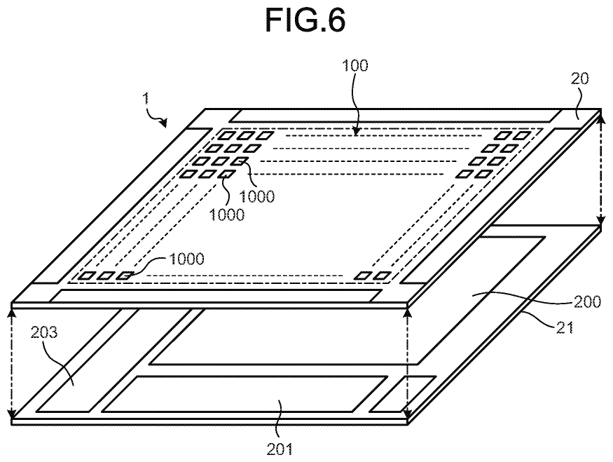

FIG. 6 is a schematic diagram illustrating an example of a device configuration applicable to the distance measuring device 1 according to each embodiment. In FIG. 6, the distance measuring device 1 is configured by stacking a light receiving chip 20 made of a semiconductor chip, and a logic chip 21. In FIG. 5, for the sake of explanation, the light receiving chip 20 and the logic chip 21 are illustrated in a separated state.

In the light receiving chip 20, the light receiving elements 1000 included in the plurality of respective pixel circuits 10 are disposed in a two-dimensional lattice pattern in the region of the pixel array unit 100. Further, in the pixel circuit 10, the transistors 1100, 1102, and 1103, the switch unit 1101, the inverter 1104, and the AND circuit 1110 are formed on the logic chip 21. The cathode of the light receiving element 1000 is connected via, for example, the coupling unit 1120 by a copper-copper connection (CCC) or the like between the light receiving chip 20 and the logic chip 21.

The logic chip 21 is provided with a logic array unit 200 including a signal processing unit that processes a signal acquired by the light receiving element 1000. The logic chip 21 can be further provided with a signal processing circuit unit 201 that processes the signal acquired by the light receiving element 1000, and an element controller 203 that controls the operation as the distance measuring device 1 in close proximity to the logic array unit 200.

For example, the signal processing circuit unit 201 can include the distance measuring processing unit 101 described above. Further, the element controller 203 can include the pixel controller 102, the overall controller 103, the clock generation unit 104, the light emission timing controller 105, and the interface 106 described above.

The configuration on the light receiving chip 20 and the logic chip 21 is not limited to this example. Further, the element controller 203 can be disposed for the purpose of the driving and control of another unit, for example, in the vicinity of the light receiving element 1000, in addition to the control of the logic array unit 200. Other than the arrangement illustrated in FIG. 6, the element controller 203 can be provided in an arbitrary region of the light receiving chip 20 and the logic chip 21 so as to have any functions.

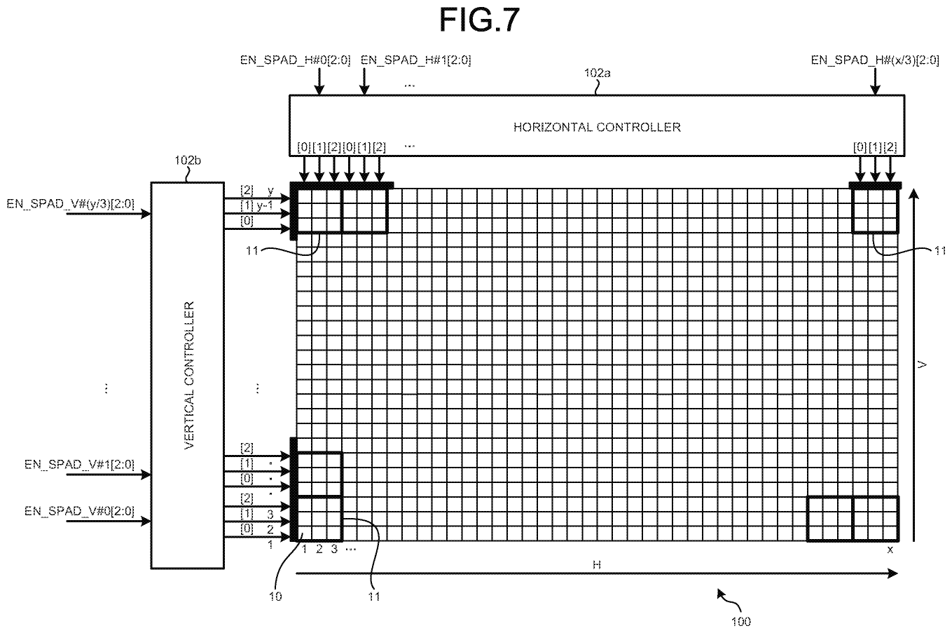

FIG. 7 is a diagram illustrating a more specific configuration example of the pixel array unit 100 according to each embodiment. The pixel controller 102 described with reference to FIG. 4 is illustrated separately as a horizontal controller 102a and a vertical controller 102b in FIG. 7.

In FIG. 7, the pixel array unit 100 includes a total of (x×y) pixel circuits 10 in x columns in the horizontal direction and y rows in the vertical direction. In addition, in FIG. 7 and the similar figures thereafter, the pixel circuit 10 is indicated by the light receiving element 1000 included in the pixel circuit 10 and having a rectangular light receiving face. That is, the pixel array unit 100 includes a configuration in which the light receiving faces of the light receiving elements 1000 as the pixel circuits 10 are disposed in a matrix.

Further, in each embodiment, respective pixel circuits 10 included in the pixel array unit 100 are controlled on a basis of an element 11 including a total of nine pixel circuits 10, three in the horizontal direction and three in the vertical direction. For example, the signal EN_SPAD_H corresponding to the above-mentioned signal XEN_SPAD_H that controls respective pixel circuits 10 in the row direction (horizontal direction), that is, on a column basis, is output from the overall controller 103 as a 3-bit signal (indicated as [2:0]) with the element 11 as a unit, and is supplied to the horizontal controller 102a. That is, by this one 3-bit signal, the signals EN_SPAD_H[0], EN_SPAD_H[1], and EN_SPAD_H[2] for the three pixel circuits 10 disposed consecutively in the horizontal direction are merged and transmitted.

In the example of FIG. 7, the signals EN_SPAD_H#0[2:0], EN_SPAD_H#1[2: 0], . . . , and EN_SPAD_H#(x/3) [2:0] are generated by the overall controller 103 in order from the element 11 at the left end of the pixel array unit 100, and are supplied to the horizontal controller 102a. The horizontal controller 102a controls each column of the corresponding element 11 according to the 3-bit value (indicated as [0], [1],

) of each signal EN_SPAD_H#0[2:0], EN_SPAD_H#1[2:0], . . . , and EN_SPAD_H#(x/3) [2:0].

Similarly, for example, the signal EN_SPAD_V corresponding to the above-mentioned signal XEN_SPAD_V that controls respective pixel circuits 10 in the column direction (vertical direction), that is, on a row basis, is output from the overall controller 103 as a 3-bit signal with the element 11 as a unit, and is supplied to the vertical controller 102b. That is, by this one 3-bit signal, the signals EN_SPAD_V[0], EN_SPAD_V[1], and EN_SPAD_V[2] for three pixel circuits 10 disposed consecutively in the vertical direction are merged and transmitted.

In the example of FIG. 7, the signals EN_SPAD_V#0[2:0], EN_SPAD_V#1[2:0], . . . , and EN_SPAD_V#(y/3) [2:0] are generated by the overall controller 103 in order from the element 11 at the lower end of the pixel array unit 100, and are supplied to the vertical controller 102b. The vertical controller 102b control each row of the corresponding element 11 according to the 3-bit value of each signal EN_SPAD_V#0[2:0], EN_SPAD_V#1[2:0], . . . , and EN_SPAD_V# (y/3)[2:0].

Although not illustrated, for example, similar to the signal EN_SPAD_V above, the signal EN_PR is output from the overall controller 103 as a 3-bit signal with the element 11 as a unit, and is supplied to the vertical controller 102b. The vertical controller 102b controls each row of the corresponding element according to the 3-bit value of each signal EN_PR.

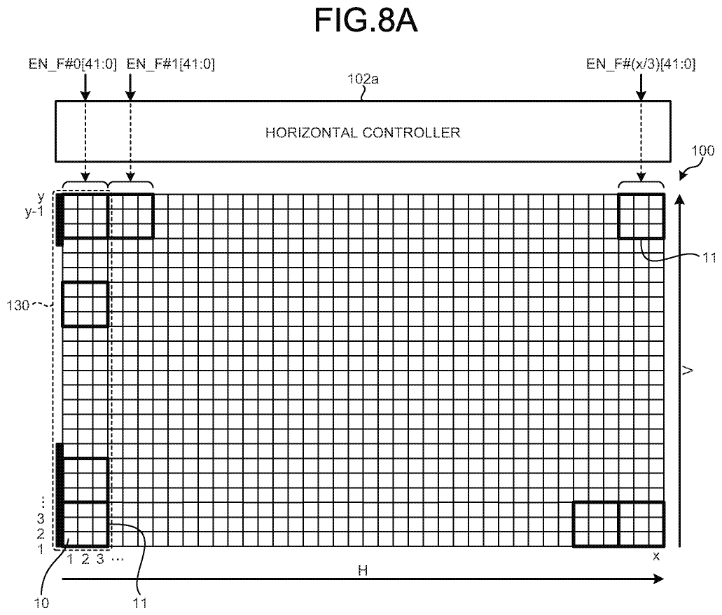

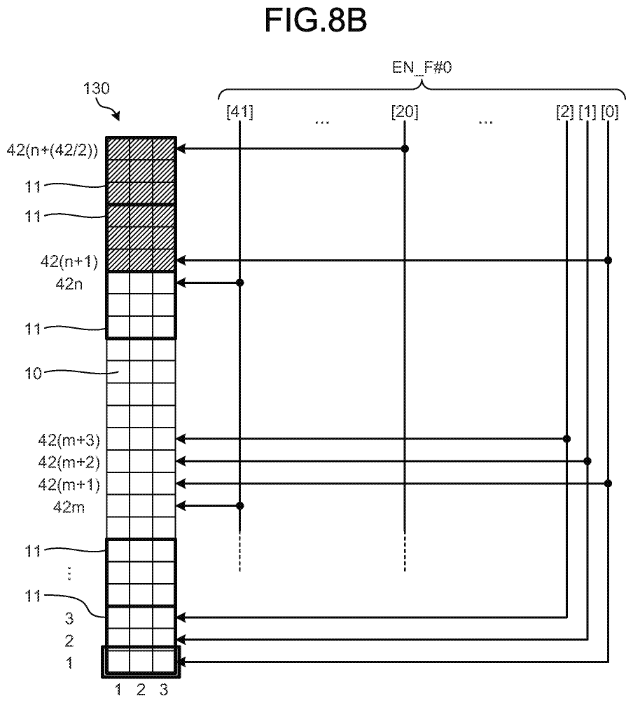

FIGS. 8A and 8B are diagrams illustrating an example of the detailed configuration of the pixel array unit 100 according to each embodiment. More specifically, FIGS. 8A and 8B illustrate control by the signal EN_F.

As illustrated in FIG. 8A, the signal EN_F is a signal supplied for the control target 130 including a plurality of adjacent columns of the pixel array unit 100. Here, the control target 130 is illustrated as including three columns that match the size of the element 11. Further, as the signal EN_F, the same signal is supplied to each row included in the control target 130 for each row with a predetermined cycle. That is, in this example in which the control target 130 includes three columns, the same signal EN_F is supplied to the three pixel circuits 10 in the same row. In FIG. 8A, as an example, the signal EN_F is a 42-bit (indicated as [41:0]) signal, and is illustrated as the same signal being supplied every 42 rows (7 rows×6). In the example of FIG. 8A, the signals EN_F#0[41:0], EN_F#1[41:0], . . . , and EN_F#(x/3) [41:0] are output by the overall controller 103 from the left end of the pixel array unit 100 every three columns, and are supplied to the horizontal controller 102a.

The horizontal controller 102a supplies each bit of respective signals EN_F#0[41:0], EN_F#1[41:0], . . . , and EN_F#(x/3) [41:0] to each row of the corresponding control target 130. As illustrated in FIG. 8B, the horizontal controller 102a supplies the signal EN_F#0[0] to, for example, to the control target 130 at the left end of the pixel array unit 100 every 42 rows, such as the first row, the 42(m+1)th row (where m is an integer of one or more), . . . , the 42(n+1)th row, . . . . Similarly, the horizontal controller 102a supplies the signal EN_F#0[2] to the second row, the 42(m+2)th row, . . . every 42 rows. In FIG. 8B, the signal EN_F#0[20] is supplied to the row of the control target 130 at the upper end, which corresponds to the first half of the unit of 42 rows.

That is, by this 42-bit signal EN_F[41:0], the signals EN_F[0], EN_F[1], . . . , and EN_F[41] for 42 sets, of three pixel circuits 10 disposed consecutively in the horizontal direction, which are disposed consecutively in the vertical direction are merged and transmitted.

In this way, it is possible to control the pixel array unit 100 differently for a plurality of columns by the signal EN_F. Further, the plurality of columns of the pixel array unit 100 is supplied with the same signal EN_F for a plurality of rows. Therefore, it is possible to control the respective pixel circuits 10 included in the pixel array unit 100 with the plurality of columns as the minimum unit in the width direction, with the plurality of rows as a cycle.

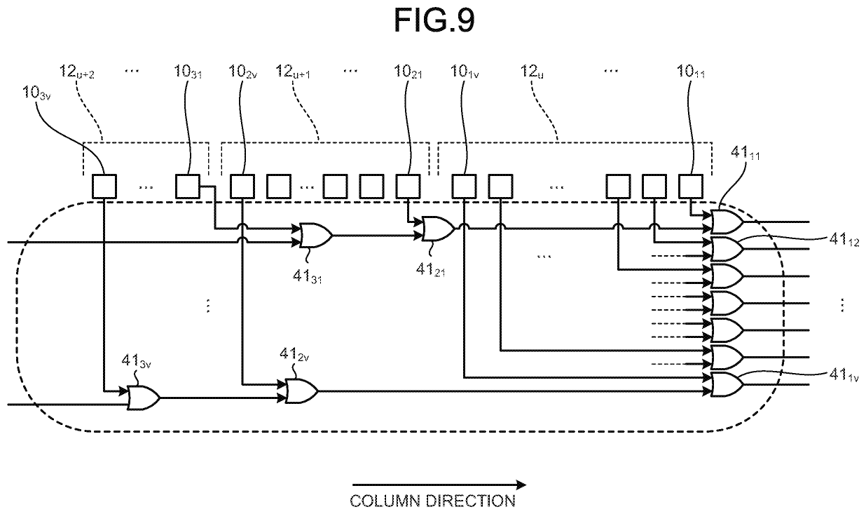

FIG. 9 is a diagram illustrating an example of a configuration for reading the signal Vpls from each pixel circuit 10 according to each embodiment. In FIG. 9, as indicated by the arrow in the figure, the horizontal direction of the figure is the column direction.

In each embodiment, a read line for reading the signal Vpls is shared for a predetermined number of pixel circuits 10 in the column direction. In the example of FIG. 9, the read line is shared for the v pixel circuits 10. For example, consider groups 12ᵤ, 12ᵤ₊₁, 12ᵤ₊₂, . . . each of which includes the v pixel circuits 10 disposed in a row. The group 12ᵤ includes the pixel circuits 10₁₁ to 10₁ᵥ, the group 12ᵤ₊₁ includes the pixel circuits 10₂₁ to 10₂ᵥ, and the group 12ᵤ₊₂ includes the pixel circuits 10₃₁ to 10₃ᵥ, . . . .

In the respective groups 12ᵤ, 12ᵤ₊₁, 12ᵤ₊₂, . . . , the read lines of the pixel circuits 10 whose positions in the groups correspond are shared. In the example of FIG. 9, when the right side of the figure is regarded as the beginning of the position the read lines of the first pixel circuit 10₁₁ of the group 12ᵤ, the first pixel circuit 10₂₁ of the group 12ᵤ₊₁, the first pixel circuit 10₃₁ of the group 12ᵤ₊₂, . . . are shared. In the example of FIG. 9, a plurality of read lines of respective pixel circuits 10₁₁, 10₂₁, 10₃₁, . . . are sequentially connected to each other via OR circuits 41₁₁, 41₂₁, 41₃₁, . . . , respectively, to share the plurality of read lines.

For example, for the group 12ᵤ, the pixel circuits 10₁₁ to 10₁ᵥ included in group 12ᵤ are provided with respective OR circuits 41₁₁, 41₁₂, . . . , and 41₁ᵥ, and the read lines of the pixel circuits 10₁₁ to 10₁ᵥ is connected to respective first input ports. Similarly for the group 12ᵤ₊₁, the pixel circuits 10₂₁ to 10^{2v} included in the group 12ᵤ₊₁ are provided with OR circuits 41₂₁ to 41₂ᵥ. Similarly for the group 12ᵤ₊₂, the pixel circuits 10₃₁ to 10ᵥ included in the group 12ᵤ₊₂ are provided with OR circuits 41₃₁ to 41₃ᵥ, respectively.

The output of each of the OR circuits 41₁₁ to 41₁ᵥ is input to, for example, the distance measuring processing unit 101.

Taking the pixel circuits 10₁₁, 10₂₁, and 10₃₁ as an example, the read line of the pixel circuit 10₁₁ is connected to the first input port of the OR circuit 41₁₁, and the output of the OR circuit 41₂₁ is connected to the second input port. The read line of pixel circuit 10₂₁ is connected to the first input port of the OR circuit 41₂₁, and the output of the OR circuit 41₃₁ is connected to the second input port. The same applies to the OR circuit 41₃₁ and subsequent circuits.

For the configuration illustrated in FIG. 9, for example, the vertical controller 102b performs control so that simultaneous reading from respective pixel circuits 10 in which positions correspond in the groups 12ᵤ, 12ᵤ₊₁, 12ᵤ₊₂, . . . is not performed by using the signal EN_SPAD_V. In other words, the vertical controller 102b performs control so as to perform reading from only one pixel circuit 10 of a plurality of pixel circuits 10 disposed every (v−1) pixels in a row. In the example of FIG. 9, the vertical controller 102b performs control so that, for example, simultaneous reading from the pixel circuit 10₁₁, the pixel circuit 10₂₁, and the pixel circuit 10₃₁ is not performed. Not limited to this, the control of simultaneous reading in the column direction can also be performed by the horizontal controller 102a using the signal EN_F.

On the other hand, in the configuration illustrated in FIG. 9, the vertical controller 102b can designate simultaneous reading from v pixel circuits 10 disposed consecutively in the column. At this time, the vertical controller 102b can designate the pixel circuits 10 from which reading is to be performed at the same time across the groups 12ᵤ, 12ₙ₊₁, 12ᵤ₊₂, . . . . That is, in the configuration illustrated in FIG. 9, v consecutive pixel circuits 10 in the column direction can be read at the same time. For example, it is possible to designate simultaneous reading from v pixel circuits 10 disposed consecutively from the third pixel circuit 1013 from the beginning included in the group 12ᵤ to the second pixel circuit 1022 from the beginning included in the group 12ᵤ₊₁.

Further, when the vertical controller 102b designates simultaneous reading from v pixel circuits 10 disposed continuously in a column, the vertical controller 102b controls so as not to perform reading from the other pixel circuits 10 in the column. Therefore, for example, the output of the OR circuit 41₁₁ is the signal Vpls read from any one pixel circuit 10 of the pixel circuits 10₁₁, 10₂₁, 10₃₁, . . . .

In this way, by connecting the read line of each pixel circuit 10 and performing read control on each pixel circuit 10, it is possible to reduce the number of read lines on a column basis.

### Example of Measurement Method Using Existing Technology

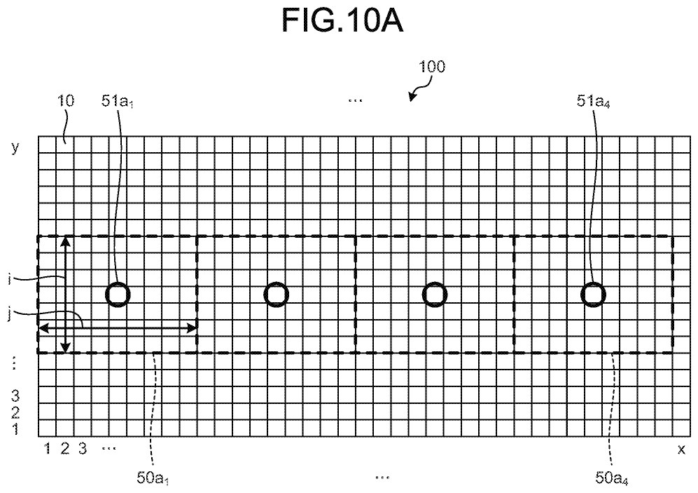

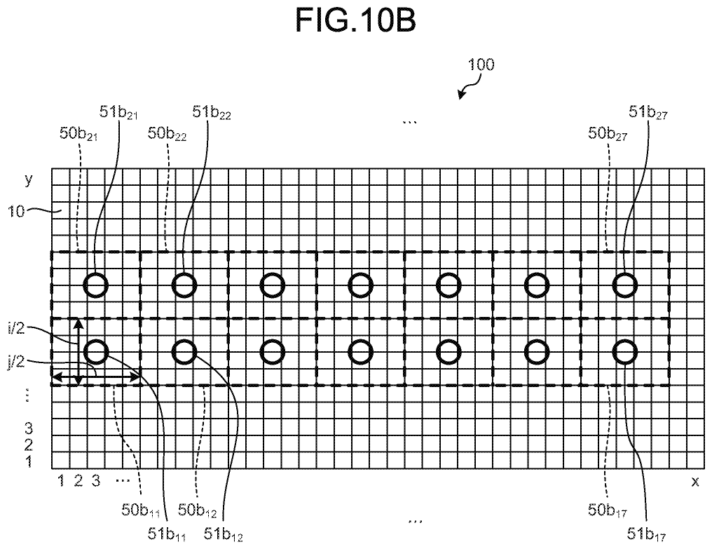

Next, prior to the description of the present disclosure, the distance measuring method by the existing technique will be schematically described. FIGS. 10A and 10B are diagrams for explaining a distance measuring method by the existing technique. FIG. 10A illustrates an example in which distance measurement is performed using a total (i×j) pixel circuits 10 having i pixel circuits in the column direction and j pixel circuits in the row direction as one pixel 50a₁ with respect to the pixel array unit 100. With reference to FIG. 4, the distance measuring processing unit 101 converts by the conversion unit 110 each signal Vpls output from each pixel circuit 10 included in the pixel 50a₁ into each time of the light reception timing. The generation unit 111 adds the time information obtained by converting the signal Vpls by the conversion unit 110 in each predetermined time range to generate a histogram. That is, the pixel 50a₁ represents an addition region for adding time information when generating a histogram. Based on this histogram, the distance information at the representative position 51a₁ in the pixel 50a₁ can be acquired.

For example, the overall controller 103 performs the process of the pixel 50a₁ on the pixels 50a₁, . . . , and 50a₄ aligned in the row direction of the target region in the pixel array unit 100. In this way, scanning is performed on the scan region in which the height in the column direction matches the height of the pixel 50a₁ in the column direction and the width in the row direction matches the width of the target region. As a result, the distance information at the representative positions 51a₁, . . . , and 51a₄ of the pixels 50a₁, . . . , and 50a₄, respectively, can be obtained. This scanning is repeatedly performed while changing the position of the scan region in the column direction of the target region on a scan region basis, and the distance information at each representative position in the target region in the pixel array unit 100 is acquired.

In the following, scanning refers to a process in which the light source unit 2 (see FIG. 4) is made to emit light, and the signal Vpls, corresponding to the light received, from the pixel circuit 10 is read for each pixel circuit 10 included in each pixel in one scan region. It is possible to perform a plurality numbers of times of light emission and reading in one time scan.

FIG. 10B illustrates an example in which the distance information is acquired at a higher resolution than that of FIG. 10A described above. In the example of FIG. 10B, each pixel 50b₁₁, 50b₁₂, . . . , 50b₁₇, 50b₂₁, 50b₂₂, . . . , and 50b₂₇ includes a total (i×j)/4 pixel circuits 10 with i/2 pixel circuits 10 in the column direction and j/2 pixel circuits 10 in the row direction. That is, the number of pixels in the example of FIG. 10B in the region having the same area as the scan region including the pixels 50a₁ to 50a₄ illustrated in FIG. 10A is four times as large as the number of pixels in the example of FIG. 10A. Therefore, the number of the representative positions from which the distance information is acquired is four times as large as that in the example of FIG. 10A in the same area, and the example of FIG. 10B has a higher resolution.

Here, the representative positions 51a₁ to 51a₄ illustrated in FIG. 10A and the representative positions 51b₁₁ to 51b₂₇ illustrated in FIG. 10B indicate the phase of the distance measurement information based on the histogram.

In the example of FIG. 10B, two pixels are missing at the right end of the pixel array unit 100, and 14 pixels 50b₁₁ to 50b₂₇ and 14 representative positions 51b₁₁ to 51b₂₇ corresponding to them are included.

According to this existing technique, the number of pixel circuits 10 included in each pixel 50b₁₁ to 50b₂₇ in the example of FIG. 10B is smaller than that in the example of FIG. 10A. Therefore, noise in the example of FIG. 10B is more likely to appear in the distance measurement result as compared with that in the example of FIG. 10A, and affects the accuracy of distance measurement.

Also, in the example of FIG. 10B, when the scan region is defined as a region including each pixel 50b₁₁ to 50b₂₇, and distance information based on each pixel 50b₁₁ to 50b₂₇ is acquired in parallel in one time scan, the amount of data processed per scan increases. Therefore, the circuit scale for performing the data process, the instantaneous power consumption, and the required internal memory in the example of FIG. 10B increase as compared with those in the example of FIG. 10A.

### First Embodiment

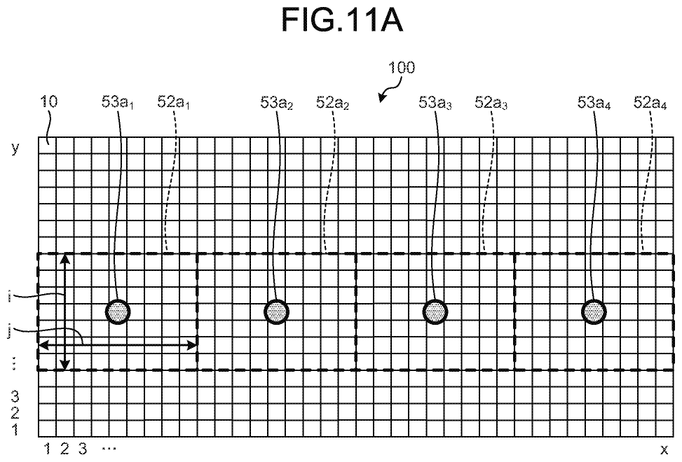

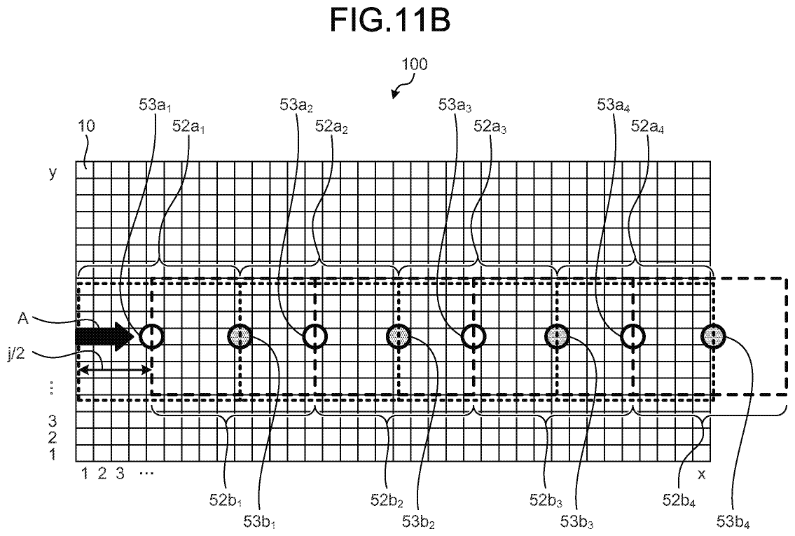

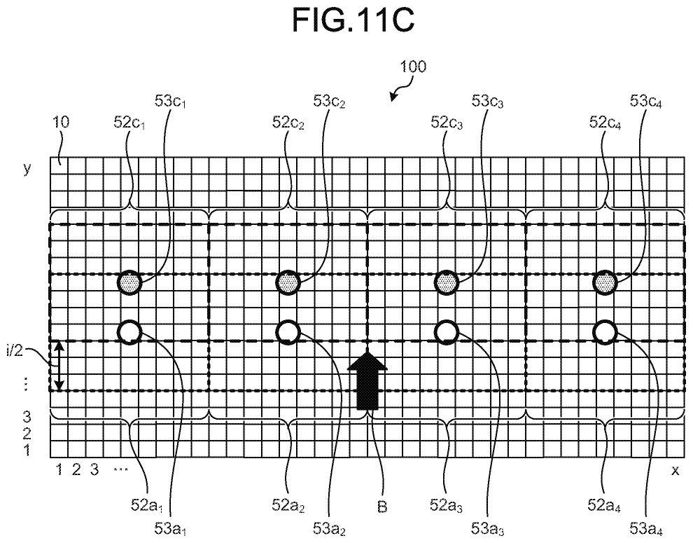

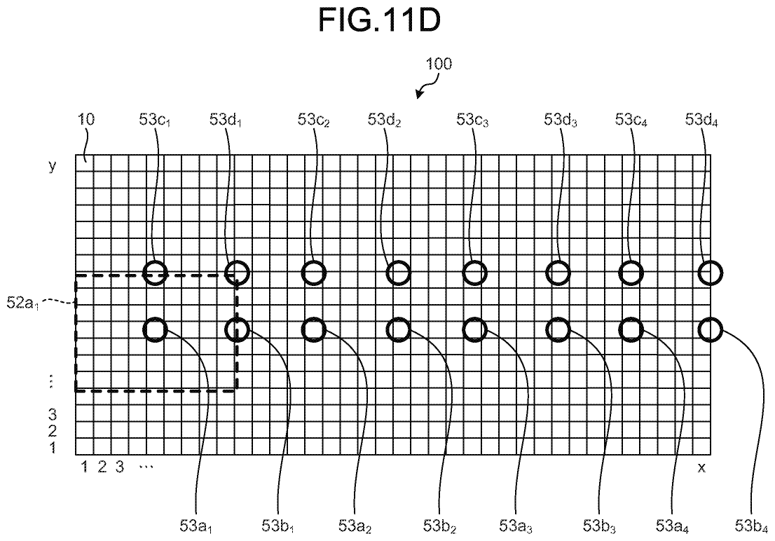

Next, the first embodiment will be described. FIGS. 11A, 11B, 11C, and 11D are diagrams schematically illustrating the distance measuring method according to the first embodiment. FIG. 11A is a diagram equivalent to FIG. 10A described above, and illustrates the example in which the row direction of the pixel array unit 100 is divided into the pixels 52a₁, 52a₂, 52a₃, and 52a₄, each including a total of (i×j) pixel circuits 10 with i pixel circuits in the column direction and j pixel circuits in the row direction. Practically, the effective region in the pixel array unit 100 is the target of the process.

For example, the overall controller 103 designates a scan region including respective pixels 52a₁, 52a₂, 52a₃, and 52a₄ for the pixel array unit 100, and performs scanning on the designated scan region.

For example, the overall controller 103 sets, for example, the above signals EN_SPAD_H and EN_SPAD_V according to the size and position of the scan region (respective pixels 52a₁, 52a₂, 52a₃, and 52a₄) to be designated. The overall controller 103 passes the set signals EN_SPAD_H and EN_SPAD_V to the horizontal controller 102a and the vertical controller 102b, respectively.

The horizontal controller 102a generates, according to the passed signal EN_SPAD_H, the signal XEN_SPAD_H that designates, on a column basis, the pixel circuits 10 included in the pixel, of the pixels 52a₁, 52a₂, 52a₃, and 52a₄, from which reading is performed to supply it to each pixel circuit 10. Similarly, the vertical controller 102b generates, according to the passed signal EN_SPAD_V, the signal XEN_SPAD_V that designates respective pixel circuits 10 in the height direction (column direction) in the scan region including respective pixels 52a₁, 52a₂, 52a₃, and 52a₄ to supply it to each pixel circuit 10.

By this scanning, in the distance measuring processing unit 101, the generation unit 111 generates a histogram for each of the pixels 52a₁, 52a₂, 52a₃, and 52a₄. The signal processing unit 112 acquires distance information at the representative positions 53a₁, 53a₂, 53a₃, and 53a₄ of the pixels 52a₁, 52a₂, 52a₃, and 52a₄, respectively, based on the generated histogram. The acquired distance information is stored in, for example, a memory of the signal processing unit 112 in association with the position information indicating the positions of the representative positions 53a₁ to 53a₄.

When the scanning of the scan region of the pixels 52a₁ to 52a₄ is completed, the overall controller 103 designates a new pixel at a position where the position of each of the pixels 52a₁ to 52a₄ is shifted in the row direction. That is, as illustrated in FIG. 11B, the overall controller 103 designates pixels 52b₁, 52b₂, 52b₃, and 52b₄ at positions where the positions of the pixels 52a₁ to 52a₄ are shifted by j/2 pixel circuits 10 in the row direction (indicated by the arrow A in the figure).

That is, the pixels 52b₁, 52b₂, 52b₃, and 52b₄ partially overlaps the corresponding pixels 52a₁, 52a₂, 52a₃, and 52a₄, respectively, before the positions are shifted.

The overall controller 103 scans the new scan region of the pixels 52b₁ to 52b₄. By this scanning, the generation unit 111 generates a histogram for each of the pixels 52b₁ to 52b₄, and the signal processing unit 112 acquires distance information at the representative positions 53b₁ to 53b₄ of the pixels 52b₁ to 52b₄, respectively, based on the generated histogram. The representative positions 53b₁ to 53b₄ are shifted (phase shift) from the above-mentioned representative positions 53a₁ to 53a₄, respectively, by j/2 pixel circuits 10 in the row direction. The acquired distance information of the representative positions 53b₁ to 53b₄ is stored in, for example, a memory included in the signal processing unit 112 association with position information indicating the positions of the representative positions 53b₁ to 53b₄.

In the example of FIG. 11B, the right half region of the pixel 52b₄ is out of the pixel array unit 100, and scanning is not performed on this right half region.

By the scanning of FIGS. 11A and 11B, one time scanning of the pixel array unit 100 in the row direction is completed. Next, the overall controller 103 designates a new pixel at a position where the position of each of the original pixels 52a₁, 52a₂, 52a₃, and 52a₄ is shifted in the column direction. That is, as illustrated in FIG. 11C, the overall controller 103 designates pixels 52c₁, 52c₂, 52c₃, and 52c₄ at positions where the positions of the pixels 52a₁ to 52a₄ are shifted by i/2 pixel circuits 10 in the column direction (indicated by the arrow B in the figure).

That is, the pixels 52c₁, 52c₂, 52c₃, and 52c₄ partially overlaps the corresponding pixels 52a₁, 52a₂, 52a₃, and 52a₄, respectively, before the positions are shifted.

The overall controller 103 scans the scan region of the pixels 52c₁ to 52c₄. By this scanning, the generation unit 111 generates a histogram for each of the pixels 52c₁ to 52c₄, and the signal processing unit 112 acquires distance information at the representative positions 53c₁ to 53c₄ of the pixels 52c₁ to 52c₄, respectively, based on the generated histogram. The representative positions 53c₁ to 53c₄ are shifted (phase shift) from the above-mentioned representative positions 53a₁ to 53a₄, respectively, by i/2 pixel circuits 10 in the column direction. The acquired distance information of the representative positions 53c₁ to 53c₄ is stored in, for example, a memory included in the signal processing unit 112 in association with position information indicating the positions of the representative positions 53c₁ to 53c₄.

With the scan region of the pixels 52c₁ to 52c₄ as a new scan region of the scan region of the pixels 52c₁ to 52c₄ in which positions in the row direction correspond, the overall controller 103 performs scanning on the scan region whose position is shifted by j/2 pixel circuits 10 in the row direction as described with reference to FIG. 11B, and further performs scanning on the scan region whose position is shifted by i/2 pixel circuits 10 in the column direction as described with reference to FIG. 11C (not illustrated).

FIG. 11D illustrates an example of the representative positions 53a₁ 53a₂, 53a₃, and 53a₄, the representative positions 53b₁, 53b₂, 53b₃, and 53b₄, the representative positions 53c₁, 53c₂, 53c₃, and 53c₄, and the representative positions 53d₁, 53d₂, 53d₃, and 53d₄, when scanning is performed according to FIGS. 11A to 11C described above, and scanning is performed on a scan region whose position is shifted by j/2 pixel circuits 10 in the row direction from a position of FIG. 11C. Thus, for example, the representative positions 53a₁ to 53b₄ and 53c₁ to 53d₄ each have an interval by j/2 pixel circuits 10 in the row direction, and by i/2 pixel circuits 10 in the column direction. This corresponds to a scan region having a size of i pixel circuits 10 in the column direction and a size of the width of the pixel array unit 100 in the row direction, and 16 representative positions 53a₁ to 53d₄ are included in this scan region. As a result, it is possible to acquire the distance information at high resolution in the existing technology described with reference to FIG. 10B.

Further, in the first embodiment, distance information at each representative position 53a₁ to 53d₄, which is represented by the pixel 52a₁ in FIG. 11D, is generated based on the signal Vpls read from each pixel circuit 10 included in a pixel having the same size as the pixel 52a₁ including (i×j) pixel circuits 10. Therefore, distance information at each representative position 53a₁ to 53d₄ is generated based on the signals Vpls read from the pixel circuits 10 whose number is four times as large as that in the example of FIG. 10B described above, and it is possible to suppress the influence of noise and the like.

Further, in one time scan, for example, a histogram is generated and distance information is acquired for four pixels 52a₁, 52a₂, 52a₃, and 52a₄. Therefore, the number of pixels to be processed in one time scan can be reduced.

In the above description, scanning is performed on all the pixels included in the scan region, but the embodiment is not limited to this example. For example, it is conceivable to scan respective pixels included in the scan region by thinning and perform the scanning by thinning a plurality of times. In this case, it is possible to further reduce the amount of process and power consumption per scan. Further, in the above description, shift of the pixel amounts is half of the column direction size (height) and half of the row direction size (width) of the pixel in the column direction and the row direction, respectively, but the embodiment is not limited to this example. That is, the amount of pixel shift may be such that part of the pixel after the shift overlaps the pixel before the shift.

### Adjustment of Scan Region According to First Embodiment

Next, the scanning control according to the first embodiment will be described. As described above, the overall controller 103 designates new pixels 52b₁ to 52b₄ by shifting the pixels 52a₁ to 52a₄ in the row direction. At this time, the overall controller 103 designates new pixels 52b₁ to 52b₄ by giving an offset in the row direction to the positions of the pixels 52a₁ to 52a₄.

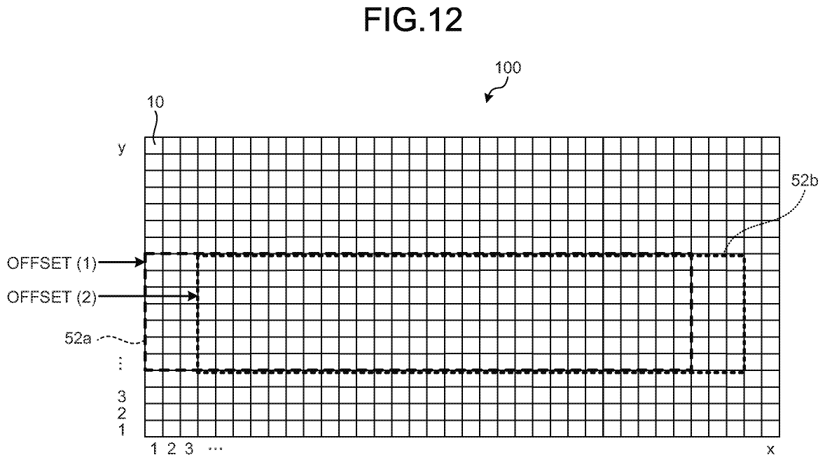

FIG. 12 is a diagram illustrating an example of the offset according to the first embodiment. In FIG. 12, the pixels 52a₁ to 52a₄ are illustrated as a region 52a including the pixels 52a₁ to 52a₄, and the pixels 52b₁ to 52b₄ are illustrated as a region 52b including the pixels 52b₁ to 52b₄. The regions 52a and 52b are designated with the height matched in the column direction in the pixel array unit 100. In the following, unless otherwise specified, a plurality of rows included in one pixel are collectively referred to as a “row”.

In the example of FIG. 12, the region 52a is designated so that the left end thereof matches the left end of the pixel array unit 100. The offset with respect to the region 52a at this time is defined as the offset (1). In the example of FIG. 12, the offset (1) has a value of “0”. On the other hand, the region 52b is designated with the left end away from the left end of the pixel array unit 100 by a predetermined distance. The offset with respect to the region 52b at this time is defined as offset (2). In the example of FIG. 12, the offset (2) is a length (width) of three pixel circuits 10.

In the first embodiment, regions 52a and 52b are scanned in the same row. When the scan of regions 52a and 52b in one row is completed, two new regions are designated by shifting the regions 52a and 52b in the column direction by a height lower than the height of the regions 52a and 52b (the number of pixel circuits 10 in the column direction).

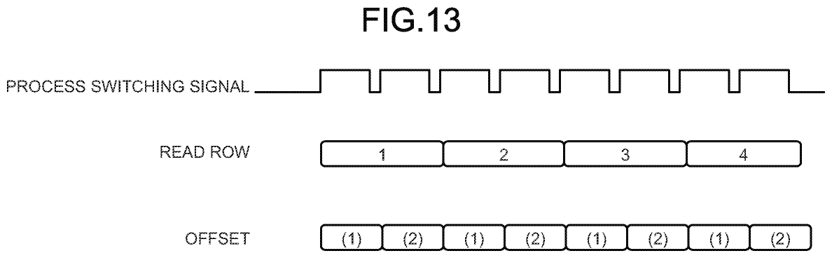

FIG. 13 is a sequence diagram of an example illustrating a method of designating an offset according to the first embodiment. In FIG. 13, the right direction represents the passage of time. Further, FIG. 13 illustrates the process switching signal, the read row instruction signal, and the offset from the top.

The process switching signal is a signal corresponding to a processing unit which is the shortest time to perform the process in one scan region. In the example of FIG. 13, the process switching signal has a period from the rising of the signal to the next rising as a processing unit. The time of each processing unit is a time in which the scan result of the first scan and the scan result of the second can be considered to have no difference when the first and second scans are performed by shifting the scan region in the row direction. For example, several tens of micro seconds can be applied as the length of the processing unit.

In FIG. 13, scanning is performed on one scan region during the period of the high state of the process switching signal. For example, during the high state period of the process switching signal, reading from respective pixel circuits 10 included in each pixel in the scan region is performed, and histogram generation based on the signals Vpls read from the respective pixel circuits 10 is performed. During this high state period, distance information may be further obtained based on the histogram.

The period in the low state of the process switching signal is a period for switching the scan region to the next scan region. During this low state period, the overall controller 103 generates signals EN_SPAD_H and EN_SPAD_V for the next scan region and passes them to the horizontal controller 102a and the vertical controller 102b. During this low state period, the horizontal controller 102a and the vertical controller 102b generates, based on the signals EN_SPAD_H and EN_SPAD_V, the signals XEN_SPAD_H and XEN_SPAD_V to supply them to the pixel array unit 100.

In FIG. 13, the read row indicates a row for which reading is performed from respective pixel circuits 10, that is, a row to which a scan region is designated. The example of FIG. 13 indicates that the read rows are designated as the first row, the second row, the third row, the fourth row, . . . . These rows has a region in which the included pixel circuits 10 overlap in the column direction. In the example of FIG. 13, the read row is switched for two time scans of the scan region.

In FIG. 13, the offset indicates the offset (1) and offset (2) for respective scan regions (regions 52a and 52b) described with reference to FIG. 12. As described above, in the first embodiment, the offset (1) and the offset (2) are switched according to the process switching signal for reading one row. As a result, reading of different scan regions is performed in one row.

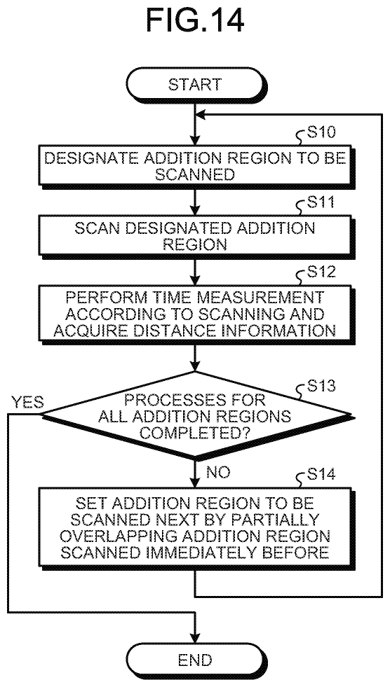

FIG. 14 is a flowchart of an example illustrating the distance measuring process according to the first embodiment. In step S10, the overall controller 103 designates an addition region (first addition region) to be scanned. For example, in the examples of FIGS. 11A to 11D, the overall controller 103 designates the pixels 52a₁ to 52a₄ as addition regions to be scanned. In the next step S11, the overall controller 103 scans using the addition region designated in step S10 as a scan region.

In the next step S12, the distance measuring processing unit 101 measures the time according to the scanning in step S11 to acquire, based on the measured time, the distance information at respective representative positions 53a₁ to 53a₄ of the pixels 52a₁ to 52a₄.

In the next step S13, the overall controller 103 determines whether the processes for all the addition regions have been completed. The overall controller 103 determines that the processes for all the addition regions are completed, for example, when the scanning and the acquisition of the distance information for all the pixels set in the pixel array unit 100 are completed. Not limited to this, the overall controller 103 can also determine whether the process of all the addition regions has been completed, for example, in response to an instruction from the outside. When the overall controller 103 determines that the processes for all the addition regions have been completed (step S13, “Yes”), the overall controller 103 ends a series of processes according to the flowchart of FIG. 14.

On the other hand, when the overall controller 103 determines in step S13 that the processes for all the addition regions have not been completed (step S13, “No”), the overall controller 103 advances the process to step S14.

In step S14, the overall controller 103 sets the addition region to be scanned next. For example, the overall controller 103 designates the position and size of the addition region to be scanned next. At this time, the overall controller 103 sets the addition region (second addition region) so that part of the addition region (second addition region) overlaps the addition region (first addition region) that was scanned immediately before (for example, pixels 52b₁ to 52b₄).

When the addition region to be scanned next is set in step S14, the process returns to step S10. In step S10, the overall controller 103 designates the addition region set in the immediately preceding step S14 as an addition region to be scanned, and executes the process after step S11.

### First Modification of First Embodiment

Next, a first modification of the first embodiment will be described. The first modification of the first embodiment is an example in which the height of the scan region (pixel height) and the movement width (movement height) when shifting the scan region in the column direction are variable.

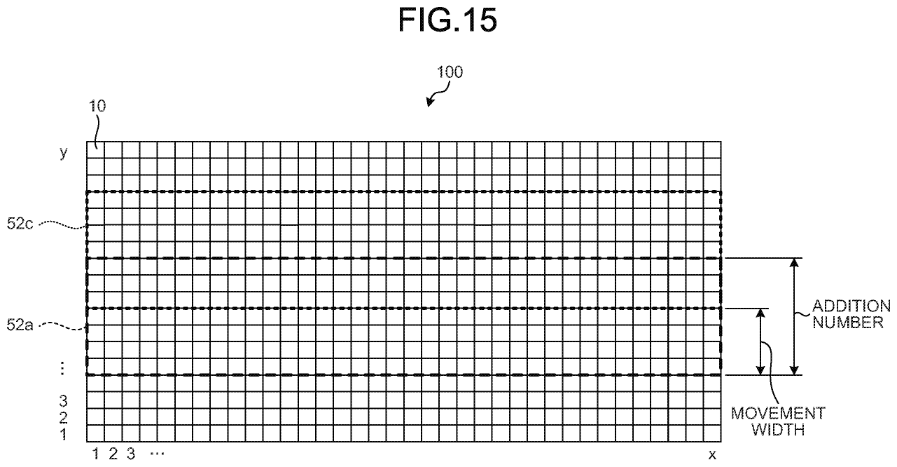

FIG. 15 is a diagram schematically illustrating an example in which the height and the movement width of the scan region are variable according to the modification of the first embodiment. FIG. 15 illustrates the region 52a corresponding to the first scan region and the region 52b, corresponding to the second scan region, obtained by shifting the first scan region in the column direction so as to partially overlap the region 52a. For example, the overall controller 103 generates the signal EN_SPAD_V according to a desired movement width and pixel height and passes it to the vertical controller 102b. The vertical controller 102b generates respective signals XEN_SPAD_V to be supplied to the pixel circuits 10 according to the passed signal EN_SPAD_V, and supplies the signals to the pixel array unit 100.

Changing the pixel height means changing the addition number when generating the histogram when the pixel width is fixed. By making the height and the movement width of the scan region independently variable, the resolution of the distance information in the plane direction and the accuracy of the distance information can each be set. By making the pixel height and the movement width variable in this way, it is possible to measure the distance according to the application and the target, for example.

### Second Modification of First Embodiment

Next, a second modification of the first embodiment will be described. In the above description, the scanning is performed by shifting respective pixels to be scanned in the row direction and the column direction over the entire effective region of the pixel array unit 100, but the embodiment is not limited to this example. In the second modification of the first embodiment, respective pixels to be scanned are shifted in the row direction and the column direction for scanning in a predetermined region of the effective region of the pixel array unit 100, and the pixels to be scanned are fixed in the region other than the predetermined region of the effective region of the pixel array unit 100.

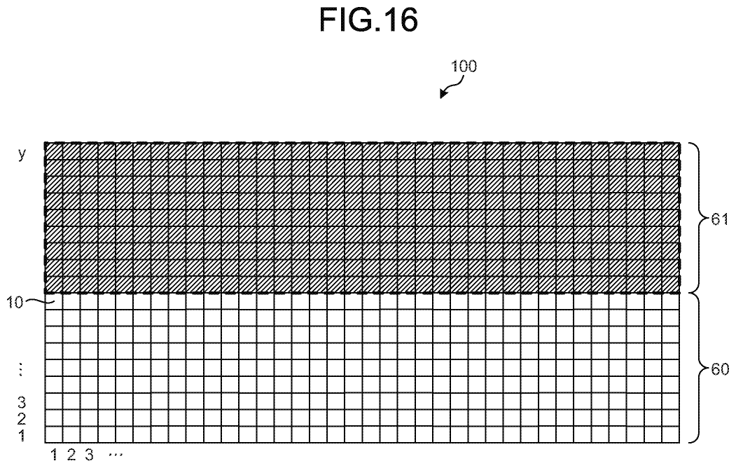

FIG. 16 is a diagram schematically illustrating a state of the pixel array unit 100 according to the second modification of the first embodiment. In FIG. 16, in a region 60, scanning is performed by shifting the pixels to be scanned in the row direction and the column direction as described above. On the other hand, in a region 61 shaded with diagonal lines in FIG. 16, the pixels to be scanned are fixed. For example, when it is known that the region 61 receives the reflected light from the subject with little movement and the region 60 receives the reflected light from the subject with large movement, such control is effective.

### Second Embodiment

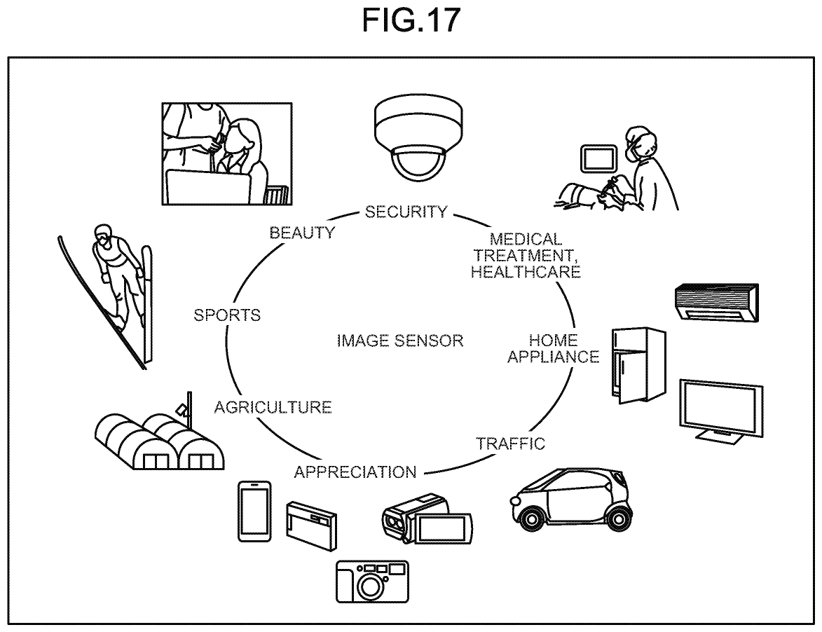

Next, as a second embodiment of the present disclosure, application examples of the first embodiment of the present disclosure and each modification of the first embodiment will be described. FIG. 17 is a diagram illustrating a usage example in which the distance measuring device 1 according to each modification of the first embodiment and the first embodiment described above according to the second embodiment is used.

The distance measuring device 1 described above can be used in various cases in which light such as visible light, infrared light, ultraviolet light, and X-ray is sensed as described below.
A device that captures images used for appreciation, such as a digital camera and a mobile device with a camera function.
A device used for traffic, such as an in-vehicle sensor that images the front, rear, surroundings, and interior of an automobile, a surveillance camera that monitors traveling vehicles and roads, a distance measuring sensor that measures a distance between vehicles, and the like, for safe driving such as automatic stop and recognition of the driver's condition, etc.
A device used for home appliances, such as a TV, a refrigerator, and an air conditioner, to take a picture of a user's gesture and operate the device according to the gesture.
A device used for medical treatment and healthcare, such as an endoscope and a device that performs angiography by receiving infrared light.
A device used for security, such as a surveillance camera for crime prevention and a camera for personal authentication.
A device used for beauty, such as a skin measuring device that photographs the skin and a microscope that photographs the scalp.
A device used for sports, such as an action camera and a wearable camera for sports applications.
A device used for agriculture, such as a camera for monitoring the condition of fields and crops.

### Further Application Example of Technology According to Present Disclosure

### Example of Application to Moving Object

The technology according to the present disclosure may be further applied to devices mounted on various moving objects such as automobiles, electric vehicles, hybrid electric vehicles, motorcycles, bicycles, personal mobility, airplanes, drones, ships, and robots.

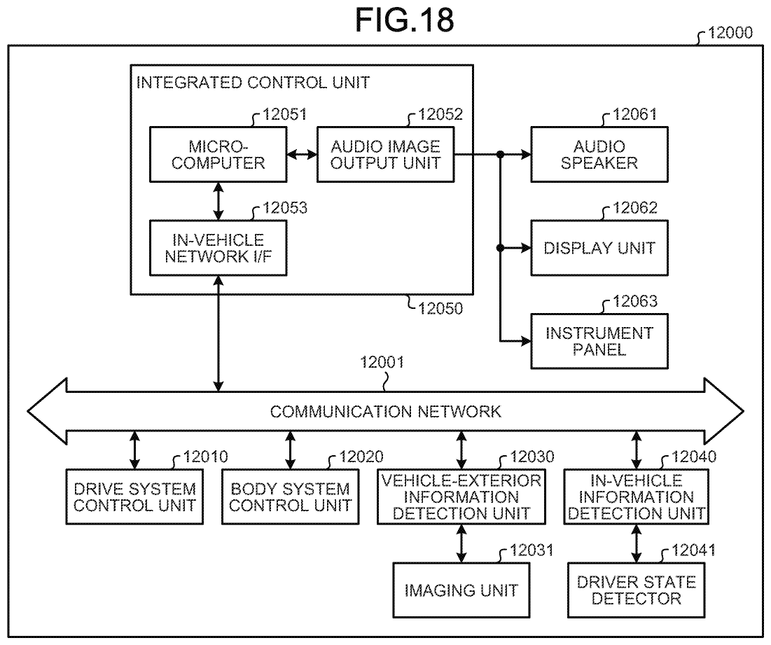

FIG. 18 is a block diagram illustrating a schematic configuration example of a vehicle control system, which is an example of a moving object control system to which the technique according to the present disclosure can be applied.

A vehicle control system 12000 includes a plurality of electronic control units connected via a communication network 12001. In the example illustrated in FIG. 18, the vehicle control system 12000 includes a drive system control unit 12010, a body system control unit 12020, a vehicle-exterior information detection unit 12030, an in-vehicle information detection unit 12040, and an integrated control unit 12050. Further, as the functional configuration of the integrated control unit 12050, a microcomputer 12051, an audio image output unit 12052, and an in-vehicle network I/F (interface) 12053 are illustrated.

The drive system control unit 12010 controls the operation of the device related to the drive system of the vehicle according to various programs. For example, the drive system control unit 12010 serves as a driving force generation unit that generates the driving force of the vehicle such as an internal combustion engine or a driving motor, a driving force transmission mechanism that transmits the driving force to the wheels, a steering mechanism for adjusting a steering angle of the vehicle, and a control device such as a braking device that generates a braking force of the vehicle.

The body system control unit 12020 controls the operation of various devices mounted on the vehicle body according to various programs. For example, the body system control unit 12020 functions as a control device for a keyless entry system, a smart key system, a power window device, or various lamps such as a head lamp, a back lamp, a brake lamp, a blinker and a fog lamp. In this case, the body system control unit 12020 may receive radio waves transmitted from a portable device that substitutes for the key or signals of various switches. The body system control unit 12020 receives the input of these radio waves or signals and controls a door lock device, a power window device, a lamp, and the like of the vehicle.

The vehicle-exterior information detection unit 12030 detects information outside the vehicle equipped with the vehicle control system 12000. For example, an imaging unit 12031 is connected to the vehicle-exterior information detection unit 12030. The vehicle-exterior information detection unit 12030 causes the imaging unit 12031 to capture an image of the outside of the vehicle and receives the picked up image. The vehicle-exterior information detection unit 12030 may perform the object detection process or the distance detection process of detecting a person, a vehicle, an obstacle, a sign, or characters on the road surface based on the received image. The vehicle-exterior information detection unit 12030 performs the image process on the received image, for example, and performs the object detection process and the distance detection process based on the result of the image process.

The imaging unit 12031 is an optical sensor that receives light to output an electrical signal according to the amount of the light received. The imaging unit 12031 can output an electrical signal as an image or can output it as distance measurement information. Further, the light received by the imaging unit 12031 may be visible light or invisible light such as infrared light.

The in-vehicle information detection unit 12040 detects in-vehicle information. For example, a driver state detector 12041 that detects the driver's state is connected to the in-vehicle information detection unit 12040. The driver state detector 12041 includes, for example, a camera that captures the driver, and the in-vehicle information detection unit 12040 may calculate the degree of fatigue or concentration of the driver, or may determine whether the driver is dozing based on the detection information input from the driver state detector 12041.

The microcomputer 12051 can calculate the control target value of the driving force generation unit, the steering mechanism or the braking device based on the information inside and outside the vehicle acquired by the vehicle-exterior information detection unit 12030 or the in-vehicle information detection unit 12040 to output a control command to the drive system control unit 12010. For example, the microcomputer 12051 can perform cooperative control for the purpose of realizing a function of an advanced driver assistance system (ADAS) including vehicle collision avoidance or impact mitigation, follow-up driving based on inter-vehicle distance, vehicle speed maintenance driving, vehicle collision warning, or vehicle lane deviation warning.

In addition, based on the information around the vehicle acquired by the vehicle-exterior information detection unit 12030 or the in-vehicle information detection unit 12040, the microcomputer 12051 can perform cooperative control for the purpose of automatic driving or the like in which the vehicle travels autonomously without depending on the operation of the driver by controlling the driving force generation unit, the steering mechanism, the braking device, etc.

Further, the microcomputer 12051 can output a control command to the body system control unit 12020 based on the information outside the vehicle acquired by the vehicle-exterior information detection unit 12030. For example, the microcomputer 12051 can control the head lamps according to the position of the preceding vehicle or the oncoming vehicle detected by the vehicle-exterior information detection unit 12030 to perform cooperative control for the purpose of anti-glare such as switching the high beam to the low beam.

The audio image output unit 12052 transmits an output signal of at least one of an audio and an image to an output device capable of visually or audibly notifying the passenger or the outside of the vehicle of information. In the example of FIG. 18, an audio speaker 12061, a display unit 12062, and an instrument panel 12063 are exemplified as output devices. The display unit 12062 may include, for example, at least one of an onboard display and a heads-up display.

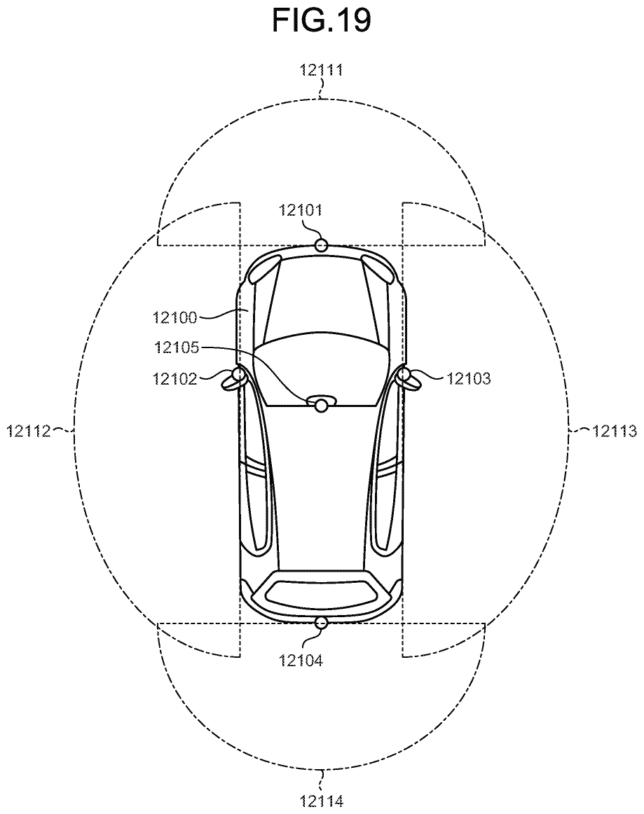

FIG. 19 is a diagram illustrating an example of the installation position of the imaging unit 12031. In FIG. 19, a vehicle 12100 has imaging units 12101, 12102, 12103, 12104, and 12105 as the imaging unit 12031.

For example, the imaging units 12101, 12102, 12103, 12104, and 12105 are provided at positions such as the front nose, the side mirrors, the rear bumper, the back door, and the upper part of the windshield in the vehicle interior of the vehicle 12100. The imaging unit 12101 provided on the front nose and the imaging unit 12105 provided on the upper part of the windshield in the vehicle interior mainly acquire an image in front of the vehicle 12100. The imaging units 12102 and 12103 provided on the side mirrors mainly acquire images of the sides of the vehicle 12100. The imaging unit 12104 provided on the rear bumper or the back door mainly acquires an image behind the vehicle 12100. The front image acquired by the imaging units 12101 and 12105 is mainly used for detecting a preceding vehicle or a pedestrian, an obstacle, a traffic light, a traffic sign, a lane, or the like.

Note that FIG. 19 illustrates an example of the shooting range of the imaging units 12101 to 12104. An imaging range 12111 indicates the imaging range of the imaging unit 12101 provided on the front nose, imaging ranges 12112 and 12113 indicate the imaging ranges of the imaging units 12102 and 12103 provided on the side mirrors, respectively, and an imaging range 12114 indicates the imaging range of the imaging unit 12104 provided on the rear bumper or the back door. For example, by superimposing the image data imaged by the imaging units 12101 to 12104, a bird's-eye view image of the vehicle 12100 as viewed from above can be obtained.

At least one of the imaging units 12101 to 12104 may have a function of acquiring distance information. For example, at least one of the imaging units 12101 to 12104 may be a stereo camera composed of a plurality of imaging devices, or may be an imaging device having pixels for phase-difference detection.

For example, by finding the distance to each three-dimensional object within the imaging ranges 12111 to 12114, and the temporal change of this distance (relative velocity with respect to the vehicle 12100) based on the distance information obtained from the imaging units 12101 to 12104, the microcomputer 12051 can extract, in particular, a three-dimensional object that is the closest three-dimensional object on the traveling path of the vehicle 12100 and that travels in substantially the same direction as the vehicle 12100 at a predetermined speed (for example, 0 km/h or more) as a preceding vehicle. Further, the microcomputer 12051 can set an inter-vehicle distance to be secured in front of the preceding vehicle in advance, and can perform automatic braking control (including follow-up stop control), automatic acceleration control (including follow-up start control), and the like. In this way, cooperative control can be performed for the purpose of automatic driving or the like in which the vehicle travels autonomously without depending on the driver's operation.

For example, the microcomputer 12051 can sort three-dimensional object data related to a three-dimensional object into a two-wheeled vehicle, an ordinary vehicle, a large vehicle, a pedestrian, and other three-dimensional objects such as a utility pole based on the distance information obtained from the imaging units 12101 to 12104 to extract them, and can use them for automatic avoidance of obstacles. For example, the microcomputer 12051 identifies obstacles around the vehicle 12100 as an obstacle that are visible to the driver of the vehicle 12100 and an obstacle that are difficult to see. The microcomputer 12051 can determine the collision risk, which indicates the risk of collision with each obstacle, and when the collision risk is above the set value and there is a possibility of collision, the microcomputer 12051 can provide a driving assistance for collision avoidance by outputting an alarm to the driver via the audio speaker 12061 or the display unit 12062, or by performing forced deceleration and avoidance steering via the drive system control unit 12010.

At least one of the imaging units 12101 to 12104 may be an infrared camera that detects infrared rays. For example, the microcomputer 12051 can recognize a pedestrian by determining whether the pedestrian is present in the picked up images of the imaging units 12101 to 12104. Such pedestrian recognition includes, for example, a procedure for extracting feature points in picked up images of the imaging units 12101 to 12104 as an infrared camera, and a procedure of performing a pattern matching process on a series of feature points indicating the outline of an object to determine whether the object is a pedestrian. The microcomputer 12051 determines that a pedestrian is present in the picked up images of the imaging units 12101 to 12104, and when the pedestrian is recognized, the audio image output unit 12052 causes the display unit 12062 to superimpose and display a square outline for emphasis on the recognized pedestrian. Further, the audio image output unit 12052 may cause the display unit 12062 to display an icon or the like indicating the pedestrian at a desired position.

An example of the vehicle control system to which the technique according to the present disclosure can be applied is described above. The technique according to the present disclosure can be applied to, for example, the imaging unit 12031 of the configuration described above. Specifically, the distance measuring device 1 according to the first embodiment of the present disclosure described above can be applied to the imaging unit 12031. By applying the technique according to the present disclosure to the imaging unit 12031, it is possible to perform distance measurement from a traveling vehicle by the distance measuring device 1 with higher resolution and higher accuracy.

Further, the effects in each embodiment described in the present specification are merely examples and are not limited, and other effects may be present.

Note that the present technology may also be configured as below.

(1) A measuring device comprising:

a light receiving unit having a plurality of light receiving elements that is disposed in a matrix array and that is included in a target region;

a controller that designates an addition region including two or more light receiving elements of the plurality of light receiving elements and that controls scanning with the designated addition region as a unit; and

a time measurement unit that measures, according to the scanning, a time from light emission timing when a light source emits light to light reception timing when each light receiving element included in the addition region receives the light to acquire a measured value, wherein

the controller

designates, as the addition region, a first addition region and a second addition region whose part overlaps the first addition region.

(2) The measuring device according to the above (1), wherein

the controller

performs scanning of the target region while shifting a position of the first addition region on a basis of the first addition region with respect to a scan region in the target region, and after the scanning, performs scanning of the target region while shifting a position of the second addition region on a basis of the second addition region with respect to the scan region.

(3) The measuring device according to the above (2), wherein

each of the first addition region and the second addition region is a rectangular region including a first number of the light receiving elements disposed continuously in a row direction of the array and a second number of the light receiving elements disposed consecutively in a column direction of the array, and

the controller

performs the scanning while shifting a position of the first addition region in the row direction on a basis of the first addition region with respect to the scan region, of the target region, including the second number of the light receiving elements continuously in the column direction, and

after the scanning, performs the scanning while shifting a position of the second addition region in the row direction on a basis of the second addition region with respect to the scan region.

(4) The measuring device according to the above (3), wherein

after performing scanning with the second addition region in the scan region as a unit, the controller performs the scanning while shifting a position of the first addition region in the row direction on a basis of the first addition region with respect to a new scan region that overlaps the scan region by a third number of the light receiving elements that is less than the second number in the column direction.

(5) The measuring device according to the above (4), wherein

the controller

designates the second number and the third number independently.

(6) The measuring device according to any one of the above (1) to (5), wherein

the controller

designates the second addition region by giving an offset in a row direction to a position of the first addition region in the target region.

(7) The measuring device according to any one of the above (1) to (6), further comprising:

a generation unit that generates a histogram related to the addition region by adding the number of the measured values in each predetermined time range based on the measured values.

(8) A distance measuring device comprising:

a light receiving unit having a plurality of light receiving elements that is disposed in a matrix array and that is included in a target region;

a controller that designates an addition region including two or more light receiving elements of the plurality of light receiving elements and that controls scanning with the designated addition region as a unit;

a time measurement unit that measures, according to the scanning, a time from light emission timing when a light source emits light to light reception timing when each light receiving element included in the addition region receives the light to acquire a measured value;

a generation unit that adds the number of the measured values in each predetermined time range based on the measured values to generate a histogram related to the addition region; and

a calculation unit that calculates a distance to an object to be measured based on the histogram, wherein

the controller

designates, as the addition region, a first addition region and a second addition region having an overlapping portion that partially overlaps the first addition region.

(9) The distance measuring device according to the above (8), wherein

the controller

performs scanning of the target region while shifting a position of the first addition region on a basis of the first addition region with respect to a scan region in the target region, and after the scanning, performs scanning of the target region while shifting a position of the second addition region on a basis of the second addition region with respect to the scan region.

(10) The distance measuring device according to the above (9), wherein

each of the first addition region and the second addition region is a rectangular region including a first number of the light receiving elements disposed continuously in a row direction of the array and a second number of the light receiving elements disposed consecutively in a column direction of the array, and

the controller

performs the scanning while shifting a position of the first addition region in the row direction on a basis of the first addition region with respect to the scan region, of the target region, including the second number of the light receiving elements continuously in the column direction, and

after the scanning, performs the scanning while shifting a position of the second addition region in the row direction on a basis of the second addition region with respect to the scan region.

(11) The distance measuring device according to the above (10), wherein

after performing scanning with the second addition region in the scan region as a unit,

the controller

performs the scanning while shifting a position of the first addition region in the row direction on a basis of the first addition region with respect to a new scan region that overlaps the scan region by a third number of the light receiving elements that is less than the second number in the column direction.

(12) The distance measuring device according to the above (11), wherein

the controller designates the second number and the third number independently.

(13) The distance measuring device according to any one of the above (8) to (12), wherein

the controller designates the second addition region by giving an offset in a row direction to a position of the first addition region in the target region.

(14) A measuring method comprising:

a designation step of designating an addition region including two or more light receiving elements of a plurality of light receiving elements, of a light receiving unit disposed in a matrix array and included in a target region;

a control step of controlling scanning with the designated addition region as a unit; and

a time measurement step of measuring, according to the scanning, a time from light emission timing when a light source emits light to light reception timing when each light receiving element included in the addition region receives the light to acquire a measured value, wherein

the designation step includes designating, as the addition region, a first addition region and a second addition region whose part overlaps the first addition region.

### REFERENCE SIGNS LIST

1 DISTANCE MEASURING DEVICE

2 LIGHT SOURCE UNIT

3 STORAGE UNIT

4 CONTROLLER

6 ELECTRONIC DEVICE

10, 10₁₁, 10₁₃, 10₁ᵥ, 10₂₁, 10₂₂, 10₂ᵥ, 10₃₁, 10₃ᵥ PIXEL CIRCUIT

11 ELEMENT

41₁₁, 41₁ᵥ, 41₂₁, 41₂ᵥ, 41₃₁, 41₃ᵥ OR CIRCUIT

50a₁, 50a₄, 50b₁₁, 50b₁₂, 50b₁₇, 50b₂₁, 50b₂₂, 50b₂₇, 52a₁, 52a₂, 52a₃, 52a₄, 52b₁, 52b₂, 52b₃, 52b₄, 52c₁, 52c₂, 52c₃, 52c₄ PIXEL

51a₁, 51a₄, 51b₁₁, 51b₁₂, 51b₁₇, 51b₂₁, 51b₂₂, 51b₂₇, 53a₁, 53a₂, 53a₃, 53a₄, 53b₁, 53b₂, 53b₃, 53b₄, 53c₁, 53c₂, 53c₃, 53c₄, 53d₁, 53d₂, 53d₃, 53d₄ REPRESENTATIVE POSITION

100 PIXEL ARRAY UNIT

102 PIXEL CONTROLLER

102a HORIZONTAL CONTROLLER

102b VERTICAL CONTROLLER

103 OVERALL CONTROLLER

1. A measuring device comprising:
a light receiving unit having a plurality of light receiving elements that is disposed in a matrix array and that is included in a target region;
a controller that designates an addition region including two or more light receiving elements of the plurality of light receiving elements and that controls scanning with the designated addition region as a unit; and
a time measurement unit that measures, according to the scanning, a time from light emission timing when a light source emits light to light reception timing when each light receiving element included in the addition region receives the light to acquire a measured value, wherein
the controller
designates, as the addition region, a first addition region and a second addition region whose part overlaps the first addition region.

2. The measuring device according to claim 1, wherein
the controller
performs scanning of the target region while shifting a position of the first addition region on a basis of the first addition region with respect to a scan region in the target region, and after the scanning, performs scanning of the target region while shifting a position of the second addition region on a basis of the second addition region with respect to the scan region.

3. The measuring device according to claim 2, wherein
each of the first addition region and the second addition region is a rectangular region including a first number of the light receiving elements disposed continuously in a row direction of the array and a second number of the light receiving elements disposed consecutively in a column direction of the array, and
the controller
performs the scanning while shifting a position of the first addition region in the row direction on a basis of the first addition region with respect to the scan region, of the target region, including the second number of the light receiving elements continuously in the column direction, and
after the scanning, performs the scanning while shifting a position of the second addition region in the row direction on a basis of the second addition region with respect to the scan region.

4. The measuring device according to claim 3, wherein
after performing scanning with the second addition region in the scan region as a unit, the controller performs the scanning while shifting a position of the first addition region in the row direction on a basis of the first addition region with respect to a new scan region that overlaps the scan region by a third number of the light receiving elements that is less than the second number in the column direction.

5. The measuring device according to claim 4, wherein
the controller
designates the second number and the third number independently.

6. The measuring device according to claim 1, wherein
the controller
designates the second addition region by giving an offset in a row direction to a position of the first addition region in the target region.

7. The measuring device according to claim 1, further comprising:
a generation unit that generates a histogram related to the addition region by adding the number of the measured values in each predetermined time range based on the measured values.

8. A distance measuring device comprising:
a light receiving unit having a plurality of light receiving elements that is disposed in a matrix array and that is included in a target region;
a controller that designates an addition region including two or more light receiving elements of the plurality of light receiving elements and that controls scanning with the designated addition region as a unit;
a time measurement unit that measures, according to the scanning, a time from light emission timing when a light source emits light to light reception timing when each light receiving element included in the addition region receives the light to acquire a measured value;
a generation unit that adds the number of the measured values in each predetermined time range based on the measured values to generate a histogram related to the addition region; and
a calculation unit that calculates a distance to an object to be measured based on the histogram, wherein
the controller
designates, as the addition region, a first addition region and a second addition region having an overlapping portion that partially overlaps the first addition region.

9. The distance measuring device according to claim 8, wherein
the controller
performs scanning of the target region while shifting a position of the first addition region on a basis of the first addition region with respect to a scan region in the target region, and after the scanning, performs scanning of the target region while shifting a position of the second addition region on a basis of the second addition region with respect to the scan region.

10. The distance measuring device according to claim 9, wherein
each of the first addition region and the second addition region is a rectangular region including a first number of the light receiving elements disposed continuously in a row direction of the array and a second number of the light receiving elements disposed consecutively in a column direction of the array, and
the controller
performs the scanning while shifting a position of the first addition region in the row direction on a basis of the first addition region with respect to the scan region, of the target region, including the second number of the light receiving elements continuously in the column direction, and
after the scanning, performs the scanning while shifting a position of the second addition region in the row direction on a basis of the second addition region with respect to the scan region.

11. The distance measuring device according to claim 10, wherein
after performing scanning with the second addition region in the scan region as a unit,
the controller
performs the scanning while shifting a position of the first addition region in the row direction on a basis of the first addition region with respect to a new scan region that overlaps the scan region by a third number of the light receiving elements that is less than the second number in the column direction.

12. The distance measuring device according to claim 11, wherein
the controller designates the second number and the third number independently.

13. The distance measuring device according to claim 8, wherein
the controller designates the second addition region by giving an offset in a row direction to a position of the first addition region in the target region.

14. A measuring method comprising:
a designation step of designating an addition region including two or more light receiving elements of a plurality of light receiving elements, of a light receiving unit disposed in a matrix array and included in a target region;
a control step of controlling scanning with the designated addition region as a unit; and
a time measurement step of measuring, according to the scanning, a time from light emission timing when a light source emits light to light reception timing when each light receiving element included in the addition region receives the light to acquire a measured value, wherein
the designation step includes designating, as the addition region, a first addition region and a second addition region whose part overlaps the first addition region.
